(19) United States
(12) Patent Application Publication
(10) Pub. No.: US 2010/0159158 A1
(43) Pub. Date: Jun. 24, 2010

(54) OPTICAL FUNCTIONAL FILM AND PRODUCTION METHOD THEREOF

(76) Inventors: Takayuki Shibata, Tokyo-to (JP); Keiji Kashima, Tokyo-to (JP); Shoji Takeshige, Tokyo-to (JP); Kenji Shirai, Tokyo-to (JP); Takeshi Haritani, Tokyo-to (JP); Yusuke Hiruma, Tokyo-to (JP); Runa Nakamura, Tokyo-to (JP); Hiroki Nakagawa, Tokyo-to (JP); Masanori Fukuda, Tokyo-to (JP); Takashi Kuroda, Tokyo-to (JP); Yuya Inomata, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 12/298,319

(22) PCT Filed: May 14, 2007
(86) PCT No.: PCT/JP2007/059880

§ 371 Date: Oct. 24, 2008

(30) Foreign Application Priority Data
May 16, 2006 (JP) 2006-137065
Mar. 28, 2007 (JP) 2007-085367

(51) Int. Cl. C09K 19/52; C09K 19/06; B29C 55/00

(52) U.S. Cl. 428/1.1; 252/299.01; 252/299.6; 264/291

(57) ABSTRACT

An optical functional film exhibiting optical biaxiality which has a high degree of freedom in optical characteristics design. The optical functional film which exhibits optical biaxiality and includes: a substrate; and an optical functional layer formed on the substrate and having a rodlike compound. The rodlike compound forms irregular-random homogeneous alignment in the optical functional layer.

### TECHNICAL FIELD

The present invention relates to an optical functional film exhibiting optical biaxiality which is used in a liquid crystal display and the like. More particularly, the invention relates to an optical functional film which has a novel alignment form of irregular-random homogeneous alignment.

### BACKGROUND ART

Owing to the characteristics of such as power saving, lightweight and thin shape, the liquid crystal displays have recently been spread at a high rate instead of the conventional CRT displays. As a common liquid crystal displays, one comprising an incident side polarizing plate 102A, an output side polarizing plate 102B and a liquid crystal cell 104 as shown in FIG. 6 can be presented. The polarizing plates 102A and 102B are provided for selectively transmitting only a linear polarization (shown schematically by the arrow in the figure) having an oscillation plane in a predetermined oscillation direction, disposed in a crossed Nicol state with their oscillation directions perpendicular with each other. Moreover, the liquid crystal cell 104 includes a large number of cells corresponding to the pixels and is disposed between the polarizing plates 102A and 102B.

As such liquid crystal displays, those of various driving systems have been known according to the alignment form of the liquid crystal materials comprising the liquid crystal cell. The mainstream driving systems of the recent liquid crystal displays are classified into such as a TN, an STN, an MVA, an IPS and an OCB. In particular, liquid crystal displays having an MVA driving system and an IPS driving system are widely used.

Here, an example is cited in which a VA (Perpendicular Alignment) system where a namatic liquid crystal having negative dielectric anisotropy is sealed (director of the liquid crystal is shown in dotted line in the figure) is employed for the liquid crystal cell 104 of the liquid crystal display 100. A linear polarization transmitted the incident side polarizing plate 102A passes through a cell portion in the non driven state out of the liquid crystal cell 104 without the phase shift so as to be blocked by the output side polarizing plate 102B. On the other hand, at the time of passing through a cell portion in the driven state out of the liquid crystal cell 104, the linear polarization has the phase shift so that a light beam according to the phase shift amount is transmitted and outputted from the output side polarizing plate 102B. Therefore, by optionally controlling the driving voltage of the liquid crystal cell 104 per cell, a desired image can be displayed on the output side polarizing plate 102B side. The liquid crystal display 100 is not limited to those having the light transmission and shielding embodiment mentioned above. A liquid crystal display provided such that a light beam outputted from a cell portion in the non driven state out of the liquid crystal cell 104 is outputted after transmitting through the output side polarizing plate 102B and a light beam outputted from a cell portion in the driven state is shielded by the output side polarizing plate 102B is also proposed.

Considering the case with a linear polarization transmitting a cell portion in the non driven state out of the VA system liquid crystal cell 104 mentioned above, since the liquid crystal cell 104 has birefringence and has different refractive indexes between a thickness direction and an plane direction, although a light beam inputted along the normal line of the liquid crystal cell 104 out of the linear polarization transmitted the incident side polarizing plate 102A is transmitted without the phase shift, a light beam incident in the direction inclined with respect to the normal line of the liquid crystal cell 104 out of the linear polarization transmitted the incident side polarizing plate 102A becomes an elliptical polarization due to the retardation generated at the time of transmitting the liquid crystal cell 104. This phenomenon is caused because the liquid crystal molecules aligned perpendicularly in the liquid crystal cell 104 functions as a positive C-plate. The size of the retardation generated to the light beam transmitted the liquid crystal cell 104 (transmitted light beam) is influenced also by factors such as the birefringence value of the liquid crystal molecules sealed inside the liquid crystal cell 104, the liquid crystal cell 104 thickness, or the wavelength of the transmitted light beam.

Due to the above-mentioned phenomenon, even in the case with a cell in the liquid crystal cell 104 is in the non driven state and a linear polarization should be transmitted as it is so as to be shielded by the output side polarizing plate 102B, a part of the light beam outputted in the direction inclined with respect to the normal line of the liquid crystal cell 104 is leaked from the output side polarizing plate 102B. Therefore, according to the conventional liquid crystal display 100 as mentioned above, a problem of the deterioration in the display quality of an image observed from the direction inclined with respect to the normal line of the liquid crystal cell 104 compared with an image observed from the front side (viewing angle dependency problem) has been present.

In order to remedy the problem of the viewing angle dependency in the conventional liquid crystal display 100 as mentioned above, a variety of techniques have been developed up to now, and a typical one thereof is a method of using an optical functional film. In the method of using the optical functional film, the problem of the viewing angle characteristics is remedied by disposing an optical functional film 40 having predetermined optical characteristics between a liquid crystal cell 104 and a polarizing plate 102B as shown in FIG. 6. As the optical functional film used to remedy such a problem of the viewing angle characteristics, retardation films exhibiting a refractive index anisotropic property have been used, and have come to be widely used as a means for remedying the viewing angle dependency in the above-mentioned liquid crystal displays.

As the above-mentioned retardation film, optical uniaxial retardation films each having single optical axis have been the mainstream of retardation films and they have been used singularly or in combination. However, as the technology in display system of the liquid crystal display advances, optical biaxial retardation films having two optical axes have come to be used as the above-mentioned retardation film. Such retardation films having optical biaxiality are advantageous because they can improve the viewing angle dependency problem of liquid crystal displays in various display systems.

Patent Document 1 discloses a retardation film made of an acetylcellulose film as the above-mentioned retardation film exhibiting the optical biaxiality. While retardation film of such an embodiment is useful in that it is easily produced because it uses a single material, it has problems such that the range of achievable optical characteristics is narrow and it is inferior in its design freedom in optical characteristics.

### Patent Document 1: Japanese Patent Laid-Open (JP-A) No. 2002-187690

### DISCLOSURE OF THE INVENTION

### Problems to be Solved by the Invention

The present invention has been made in view of the above-mentioned problems, and a main object thereof is to provide an optical functional film exhibiting optical biaxiality which has a high degree of freedom in optical characteristics design.

### Means to Solve the Problems

To solve the above-mentioned problems, the present invention provides an optical functional film which exhibits optical biaxiality and comprises: a substrate; and an optical functional layer formed on the substrate and having a rodlike compound, characterized in that the rodlike compound forms irregular-random homogeneous alignment in the optical functional layer.

As the rodlike compound forms irregular-random homogeneous alignment in the optical functional layer of the present invention, an optical functional film excellent in exhibiting optical biaxiality can be obtained while using a substrate having optional optical characteristics. Accordingly, an optical functional film exhibiting optical biaxiality which has a high degree of freedom in optical characteristics design can be obtained in the present invention.

The optical functional film of the present invention preferably realizes the relation: nx>ny>nz among a refractive index “nx” in a slow axis direction of an in-plane direction, a refractive index “ny” in a fast axis direction of an in-plane direction, and a refractive index “nz” in a thickness direction. Thereby, the optical functional film of the present invention is made further excellent in exhibiting optical biaxiality.

The optical functional film of the present invention preferably has an in-plane retardation (Re) in the range of 10 nm to 200 nm. Further, a retardation in a thickness direction (Rth) is preferably in the range of 75 nm to 300 nm. Thereby, the optical characteristics realized by the optical functional film of the present invention can be easily made in the range suitable for an application such as optical compensating film for the liquid crystal display.

Further, the rodlike compound of the present invention preferably has a polymerizable functional group. This is because, when the rodlike compound has the polymerizable functional group, the rodlike compound can be fixed through polymerization. Therefore, the optical functional film which has excellent alignment stability and is unlikely to change the optical characteristics can be obtained by fixing the rodlike compound in such a state that it forms the irregular-random homogeneous alignment in the optical functional layer.

Moreover, the rodlike compound of the present invention is preferably a liquid crystalline material. This is because, when the rodlike compound is the liquid crystalline material, the optical functional layer can exhibit excellent optical characteristics per unit thickness.

In the present invention, the above-mentioned liquid crystalline material is preferably a material exhibiting a nematic phase. This is because, when the liquid crystalline material is the material exhibiting the nematic phase, the irregular-random homogeneous alignment can be more effectively formed.

Still further in the present invention, it is preferable that the substrate realizes the relation: nx≠ny among a refractive index “nx” in a slow axis direction of an in-plane direction, and a refractive index “ny” in a fast axis direction of the in-plane direction. It is also preferable that the substrate realizes the relation: nx≠ny≠nz among a refractive index “nx” in a slow axis direction of an in-plane direction, a refractive index “ny” in a fast axis direction of an in-plane direction, and a refractive index “nz” in a thickness direction.

This is because such characteristics of the substrate can make optical characteristics of the optical functional film of the present invention suitable for an optical compensating film for a liquid crystal display.

The rodlike compound of the present invention preferably has a rodlike-main skeleton having plural benzene rings; and further characterized in that a Raman peak intensity ratio (1605 cm⁻¹/2942 cm⁻¹) in a slow axis direction of in-plane of the optical functional layer is 1.1 times or more of a Raman peak intensity ratio (1605 cm⁻¹/2942 cm⁻¹) in a fast axis direction of the in-plane. Thereby, the optical functional layer of the present invention can be made excellent in having a good in-plane retardation (Re).

In the present invention, the rodlike compound preferably has a rodlike-main skeleton having plural benzene rings; and is preferably characterized in that a cross-section in a thickness direction of the optical functional layer has a Raman peak intensity ratio (1605 cm⁻¹/2942 cm⁻¹) in a direction perpendicular to the thickness direction which is 1.1 times or more of a Raman peak intensity ratio (1605 cm⁻¹/2942 cm⁻¹) in a direction parallel to the thickness direction. Thereby, the optical functional layer of the present invention can be made excellent in having a good retardation in a thickness direction (Rth).

In the present invention, the substrate is preferably made of a cellulose derivative. By using a cellulose derivative having excellent moisture permeability as the substrate, moisture contained in a polarizer can be volatilized through a film during the production process when, for example, a polarizing plate is produced using the optical functional film of the present invention. Further, this is also because such substrate is excellent in yield since the substrate: has excellent adhesion to a polarizing film which contains PVA as a main material, and requires no liner unlike norbornene resin so that it has less problem concerning foreign matters.

The present invention provides a production method of an optical functional film to produce an optical functional film comprising: a substrate which realizes the relation: nx≠ny or nx≠ny≠nz among a refractive index “nx” in a slow axis direction of an in-plane direction, a refractive index “ny” in a fast axis direction of an in-plane direction, and a refractive index “nz” in a thickness direction; and an optical functional layer formed on the substrate, in which the optical functional layer exhibits optical biaxiality and contains a rodlike compound forming irregular-random homogeneous alignment, characterized in that the production method comprises a step of stretching an optical film which comprises: a substrate having at least a property as an optically negative C-plate; and an optical functional layer formed directly on the substrate, in which the optical functional layer exhibits optical uniaxiality and contains a rodlike compound forming random homogeneous alignment.

In the present invention, an optical functional film having high degree of freedom in optical characteristics design is easily produced because an optical functional film comprising: a substrate which realizes the relation: nx≠ny or nx≠ny≠nz among a refractive index “nx” in a slow axis direction of an in-plane direction, a refractive index “ny” in a fast axis direction of an in-plane direction, and a refractive index “nz” in a thickness direction; and an optical functional layer, formed on the substrate, which exhibits optical biaxiality and contains a rodlike compound forming irregular-random homogeneous alignment, is easily formed.

### EFFECTS OF THE INVENTION

The present invention achieves an effect of providing an optical functional film exhibiting optical biaxiality which has a high degree of freedom in optical characteristics design.

### BRIEF DESCRIPTION OF THE DRAWINGS

FIG. 1 is a schematically perspective view showing one example of the optical functional film of the present invention.

FIGS. 2A to 2C are each a schematically perspective view showing another example of the optical functional film of the present invention.

FIGS. 3A and 3B are each a schematic view showing one example of the producing method of an optical functional film of the present invention.

FIG. 4 is a schematic view showing one example of the optical film used in the producing method of an optical functional film of the present invention.

FIGS. 5A and 5B are each an example of in-plane Raman Scattering Spectrum of the optical functional film for the present invention.

FIG. 6 is a schematic view showing one example of common liquid crystal display.

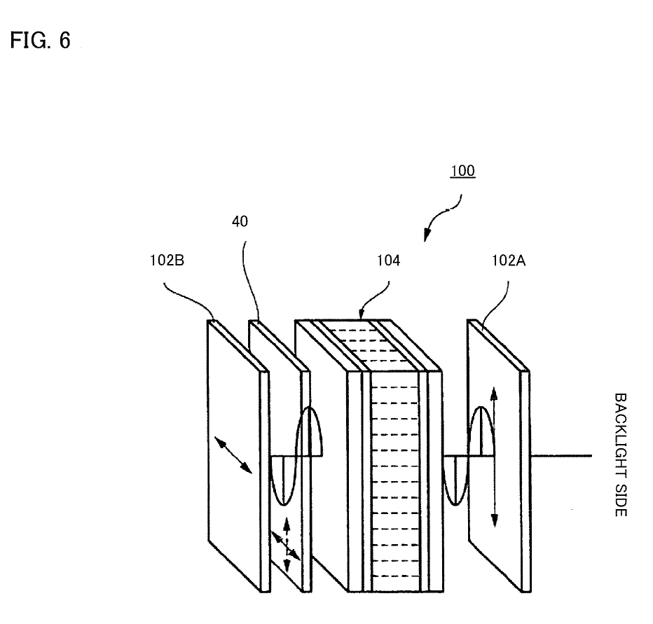

### EXPLANATION OF REFERENCES

1, 1′ . . . substrate
2, 2′ . . . optical functional layer
3 . . . rodlike compound
10 . . . optical functional film
20 . . . optical film
40 . . . retardation film
100 . . . liquid crystal display
102A, 102B . . . polarizing plate
104 . . . liquid crystal cell

### BEST MODE FOR CARRYING OUT THE INVENTION

The present invention relates to an optical functional film and a producing method of the optical functional film. Hereinafter, the optical functional film and the producing method of an optical functional film will be explained in detail.

### A. Optical Functional Film

First, an optical functional film of the present invention will be explained. The optical functional film of the present invention exhibits optical biaxiality and comprises: a substrate; and an optical functional layer formed on the substrate and having a rodlike compound, characterized in that the rodlike compound forms irregular-random homogeneous alignment in the optical functional layer.

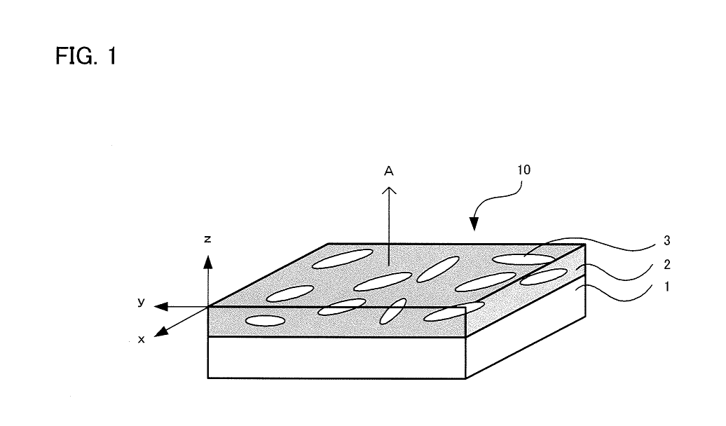

Next, the optical functional film of the present invention will be explained with reference to the drawings. FIG. 1 is a schematically perspective view showing one example of the optical functional film of the present invention. As shown in FIG. 1, the optical functional film 10 of the present invention comprises the substrate 1 and the optical functional layer 2 formed directly on the substrate 1.

In such an example, the optical functional film 10 of the present invention is characterized in that the optical functional layer 2 contains the rodlike compound 3 which forms irregular-random homogeneous alignment and that the optical functional film 10 exhibits optical biaxiality in its entirety.

In the present invention, an optical functional film excellent in exhibiting optical biaxiality can be obtained by using a substrate having optional optical characteristics because the rodlike compound forms irregular-random homogeneous alignment in the optical functional layer. Thereby, an optical functional film exhibiting optical biaxiality which has a high degree of freedom in optical characteristics design can be obtained in the present invention.

Here, the word “optical biaxiality” denotes that a subject has two optical axes which are optically isotropic. The optical functional film of the present invention is characterized in exhibiting optical biaxiality. Exhibition of the optical biaxiality can be evaluated by confirming the realization of the relation: nx≠ny≠nz among a refractive index “nx” in a slow axis direction of the optical functional film, an refractive index “ny” in a fast axis direction of the optical functional film, and the refractive index “nz” in a thickness direction.

The realization of the above-mentioned relation among the “nx”, “ny” and “nz” can be measured by, for example, a parallel Nicol rotation method with use of KOBRA-WR manufactured by Oji Scientific Instruments.

Next, the irregular-random homogeneous alignment in the present invention will be explained. The irregular-random homogeneous alignment in the present invention is an alignment state which is formed by the rodlike compound contained in the optical functional layer. Since the rodlike compound has such an alignment state, the optical biaxiality can be provided to the optical functional film of the present invention.

The irregular-random homogeneous alignment of the rodlike compound in the present invention has at least three features as mentioned below. That is, the irregular-random homogeneous alignment in the present invention has at least the following three features:

first, when the optical functional layer is viewed just from the perpendicular direction to the surface of the optical functional layer, the alignment directions of the rodlike compounds has anisotropy (hereinafter, it may be referred to simply as “anisotropy”);

second, sizes of domains formed by the rodlike compounds in the optical functional layer are smaller than the wavelengths in the visible light zone (hereinafter, it may be referred to simply as “dispersibility”); and

third, the rodlike compounds of the optical functional layer are aligned in a plane parallel to the surface of the optical functional layer (the plane parallel to the XY-plane in FIG. 1) (hereinafter, it may be referred to simply as “in-plane alignment properties”).

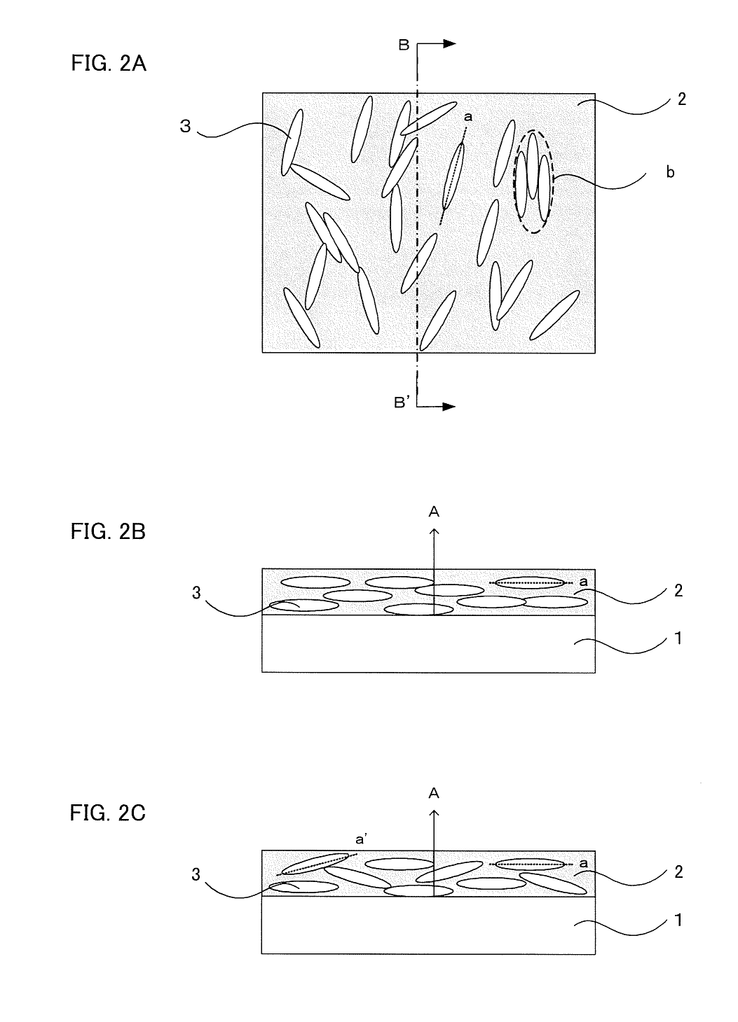

Next, the irregular-random homogeneous alignment of the present invention will be explained with reference to the drawings. FIG. 2A is a schematic view in which the optical functional film of the present invention is viewed just from the perpendicular direction (normal line direction, i.e., Z-direction) to the surface (XY-plane) of the optical functional layer which is shown by “A” in FIG. 1 mentioned above. Meanwhile, FIGS. 2B and 2C are each a sectional view from B-B′ linear arrows in FIG. 2A.

First, “anisotropy” possessed by the irregular-random homogeneous alignment of the present invention will be explained with reference to FIG. 2A. The “anisotropy” means that when the optical functional film 10 of the present invention is viewed just from the perpendicular direction to the surface of the optical functional layer 2 as shown in FIG. 2A, the rodlike compounds 3 are aligned averagely to one direction in the optical functional layer 2.

In other words, when a probability distribution function (probability density function) of each rodlike compound molecules aligned in each direction in the XY-plane (optical functional layer surface) is calculated, the probability distribution function has its peak in a specific direction in the XY-plane (X-direction in the example shown in FIGS. 2A to 2C) while also the rodlike compounds are distributed as such that they have a certain distribution manner in their alignment directions (dispersion range in their alignment directions). To put it differently, alignment directions of long axes of the rodlike compound molecules are not perfectly in parallel in all molecules, but not in a total disorder. One example of this is shown in FIGS. 2A to 2C.

Here, when the alignment directions of the rodlike compounds 3 are to be explained in the present invention, the long-axis direction of the molecule (hereinafter, referred to as “molecular axis”) shown by “a” in FIG. 2A is considered as a reference. Therefore, that the alignment directions of the rodlike compounds are aligned in one direction means that the molecular axes “a” of the rodlike compounds 3 contained in the optical functional layer are aligned averagely in one direction.

As explained above, the “anisotropy” in the present invention does not require a state where the rodlike compounds are aligned perfectly in one direction. It is suffice with a state where the alignment directions of the rodlike compounds are averagely aligned in one direction, and the degree of which is sufficient if the desired optical biaxiality can be provided to the optical functional layer. The degree of the “anisotropy” will be explained later.

Next, the “dispersibility” possessed by the irregular-random homogeneous alignment in the present invention will explained with reference to FIG. 2A. The “dispersibility” means that when a domain “b” is formed by the rodlike compounds 3 in the optical functional layer 2 as shown in FIG. 2A, the sizes of the domains “b” are smaller than the wavelengths in the visible light zone. In the present invention, the smaller the sizes of the domain “b” are, the more preferable they are. It is the most preferable that the rodlike compounds are dispersed in a single molecular state.

The “in-plane alignment properties” possessed by the irregular-random homogeneous alignment in the present invention will be explained with reference to FIG. 2B. The “in-plane alignment properties” means that as shown in FIG. 2B, the rodlike compounds 3 align their molecular axes “a”, in the optical functional layer 2, substantially perpendicular (substantially parallel to the XY-plane in FIG. 1) to the normal direction A (equivalent to the Z-direction in FIG. 1) of the optical functional layer 2. The “in-plane alignment properties” in the present invention not only means the case where as shown in FIG. 2B, the molecular axes “a” of all the rodlike compounds 3 in the optical functional layer 2 are substantially perpendicular to the normal direction A, but also includes a case where even if there are rodlike compounds 3 of which molecular axes “a′” are not perpendicular, in the optical functional layer 2, to the normal direction A as shown in FIG. 2C, the average direction of the molecular axes “a” of the rodlike compounds 3 existing in the optical functional layer 3 is substantially perpendicular to the normal direction A.

In other words, in FIGS. 2A to 2C, although the axial directions of each rodlike compound molecules are distributed, the axial direction averaged regarding all of the rodlike compound molecules substantially exists within the XY-plane.

According to the optical functional film of the present invention, the rodlike compounds form the irregular-random homogeneous alignment. Thus, the relation: nx>ny>nz is easily realized among a refractive index “nx” in an X-direction, a refractive index “ny” in a Y-direction and a refractive index “nz” in a Z-direction shown in FIG. 1, and the optical functional film of the present invention can have optical biaxiality.

As explained above, the irregular-random homogeneous alignment in the present invention is characterized by exhibiting “anisotropy”, “dispersibility” and “in-plane alignment properties”. That the rodlike compounds have the irregular-random homogeneous alignment can be confirmed by the following methods.

First, a method for confirming the “anisotropy” possessed by the irregular-random homogeneous alignment in the present invention will be explained. The “anisotropy” can be confirmed by evaluating the in-plane retardation (Re) of the optical functional layer constituting the optical functional film of the present invention (hereinafter, may simply referred to “Re”).

That the rodlike compounds have the “anisotropy” can be confirmed by ascertaining that the value of in-plane retardation (Re) of the optical functional layer is within the range which allows the optical functional layer to exhibit optical biaxiality. In particular, the in-plane retardation (Re) of the optical functional layer is preferably within the range of 5 nm to 300 nm, further preferably within the range of 10 nm to 200 nm and most preferably within the range of 40 nm to 150 nm.

Here, the Re is a value expressed by a formula: Re=(nx−ny)×d, in which “nx” and “ny” are respectively a refractive index in the slow axis direction (the direction with the largest refractive index) and a refractive index in the fast axis direction (the direction with the smallest refractive index) of in-plane of the optical functional layer constituting the optical functional film of the present invention, and “d” is the thickness (nm) of the optical functional layer of in-plane of the retardation layer constituting the optical functional film of the present invention.

For example, the Re of the optical functional layer can be determined by subtracting the Re indicated by other layer(s) than the optical functional layer from the Re of the optical functional film. That is, the Re of the optical functional layer can be determined by measuring the Re of the entire optical functional film and the Re of a remainder in which the optical functional layer is removed from the optical functional film, and subtracting the latter Re from the former Re. For example, Re can be measured by a parallel Nicol rotation method with use of KOBRA-WR manufactured by Oji Scientific Instruments.

When a rodlike compound having a rodlike-main skeleton having plural benzene rings is used as the above-mentioned rodlike compound, the “anisotropy” can be confirmed by measuring a Raman peak intensity ratio (1605 cm⁻¹/2942 cm⁻¹) in an in-plane direction of the optical functional layer. In other words, the “anisotropy” can be confirmed if a Raman peak intensity (1605 cm⁻¹/2942 cm⁻¹) in a slow axis direction of in-plane of the optical functional layer is bigger than a Raman peak intensity (1605 cm⁻¹/2942 cm⁻¹) in a fast axis direction of the in-plane. Particularly, in the present invention, the Raman peak intensity ratio (1605 cm⁻¹/2942 cm⁻¹) in a slow axis direction of in-plane of the optical functional layer is preferably 1.1 times or more of the Raman peak intensity ratio (1605 cm⁻¹/2942 cm⁻¹) in a fast axis direction of the in-plane, more preferably 1.15 times or more, and most preferably within the range of 1.20 to 3.00 times.

Here, the “Ramanpeak intensity ratio (1605 cm⁻¹/2942 cm⁻¹)” denotes to a spectrum ratio between “spectrum light intensity at 1605 cm⁻¹ wavelength/spectrum light intensity at 2942 cm⁻¹ wavelength)” in the Raman spectrum.

The Raman peak intensity ratio (1605 cm⁻¹/2942 cm⁻¹) in the present invention can be obtained as follows. Using, for example, a laser Raman spectrophotometer (Trade name: NRS-300, manufactured by JASCO Corporation), a measuring light is entered into the optical functional layer in a manner that the electric field oscillating surface of the liner-polarized light coincides with the slow axis direction and the fast axis direction of in-plane of the optical functional layer. Each Raman scattering spectrum is measured regarding the slow axis direction and the fast axis direction in the plane. Subsequently, a peak intensity at 1605 cm⁻¹ (peak derived by C—H binding) and a peak intensity at 2942 cm⁻¹ (peak derived by benzene ring) are evaluated and the Raman peak intensity is obtained. The Raman spectrum is measured using the laser Raman spectrophotometer and under conditions of: 15 seconds of exposing time, 8 times of integrating time and 532.11 nm in excitation wavelength.

Next, a method for confirming the “dispersibility” possessed by the irregular-random homogeneous alignment in the present invention will be explained. The “dispersibility” can be confirmed by ascertaining that the haze value of the optical functional layer constituting the optical functional film of the present invention is in the range denoting that the sizes of the domains of the rodlike compounds are not more than the wavelengths in the visible light zone. Particularly, in the present invention, the haze value of the optical functional layer is preferably in the range of 0% to 5%, more preferably in the range of 0% to 1% and most preferably in the range of 0% to 0.5%.

Here, the haze value of the optical functional layer can be determined by subtracting the haze value of the other layer(s) than the optical functional layer from that of the optical functional film, for example. That is, the haze value of the optical functional layer can be determined by measuring the haze value of the entire optical functional film and that of a remainder in which the optical functional layer is removed from the optical functional film, and subtracting the latter haze value from the former haze value. A value measured according to JIS K7105 is used as the above haze value.

The concrete size of the above-mentioned domain in the present invention is preferably not more than the wavelengths of the visible lights, that is, not more than 380 nm, more preferably not more than 350 nm, and particularly preferably not more than 200 nm. In the present invention, note that since the rodlike compound is dispersed in the form of single molecules, the lower limit of the domains is that of the single molecule of the rodlike compound. The size of such a domain can be evaluated by observing the optical functional layer with a polarization microscope, an AFM, an SEM or a TEM.

Next, a method for confirming the “in-plane alignment properties” possessed by the irregular-random homogeneous alignment in the present invention will be explained. The “in-plane alignment properties” can be confirmed by ascertaining that the Re value of the optical functional layer constituting the optical functional film of the present invention is in the above-mentioned range and that the optical functional layer in the present invention has the retardation value in the thickness direction (hereinafter, may be referred simply as Rth) to the extent that the optical functional film can exhibit optical biaxiality. Particularly, the Rth value of the optical functional layer in the present invention is preferably in a range of 50 nm to 400 nm, more preferably in the rage of 75 nm to 300 nm, and most preferably in the range of 100 nm to 250 nm.

Here, the Rth value is a retardation value, which is represented by a formula: Rth={(nx+ny)/2−nz}×d, in which “nx” and “ny” are respectively a refractive index in the slow axis direction (the direction with the largest refractive index) and a refractive index in the fast axis direction (the direction with the smallest refractive index) and of in-plane of the optical functional layer constituting the optical functional film of the present invention, “nz” is a refractive index in the thickness direction, and “d” is the thickness (nm) of the optical functional layer.

Here, the Rth in the present invention denotes an absolute value of that represented by the above formula.

The Rth of the optical functional layer can be determined by subtracting the Rth denoted by the other layer(s) than the optical functional layer from the Rth of the optical functional film, for example. That is, the Rth of the optical functional layer can be determined by measuring the Rth of the entire optical functional film and the Rth of a remainder in which the optical functional layer is removed from the optical functional film, and subtracting the latter Rth from the former Rth. The Rth can be measured by the parallel Nicol rotation method with use of the KOBRA-WR manufactured by Oji Scientific Instruments.

When a rodlike compound having a rodlike-main skeleton having plural benzene rings is used as the above-mentioned rodlike compound, the “in-plane alignment properties” can be confirmed by measuring a Raman peak intensity ratio (1605 cm⁻¹/2942 cm⁻¹) in a thickness direction of the optical functional layer. In other words, the “in-plane alignment properties” can be confirmed when a cross-section in a thickness direction of the optical functional layer has a Raman peak intensity ratio (1605 cm⁻¹/2942 cm⁻¹) in a direction perpendicular to the thickness direction bigger than a Raman peak intensity ratio (1605 cm⁻¹/2942 cm⁻¹) in a direction parallel to the thickness direction. Particularly, in the present invention, a cross-section in a thickness direction of the optical functional layer has a Raman peak intensity ratio (1605 cm⁻¹/2942 cm⁻¹) in a direction perpendicular to the thickness direction which is preferably 1.1 times or more of the a Raman peak intensity ratio (1605 cm⁻¹/2942 cm⁻¹) in a direction parallel to the thickness direction, more preferably 1.50 times or more, and most preferably within the range of 1.20 to 3.00 times.

Here, the “Ramanpeak intensity ratio (1605 cm⁻¹/2942 cm⁻¹)” denotes to a spectrum ratio between “spectrum light intensity at 1605 cm⁻¹ wavelength/spectrum light intensity at 2942 cm⁻¹ wavelength” in the Raman spectrum.

The Raman peak intensity ratio (1605 cm⁻¹/2942 cm⁻¹) in the present invention can be obtained as follows. Using, for example, a laser Raman spectrophotometer (NRS-300 manufactured by JASCO Corporation), a measuring light is entered into the cross-section in a thickness direction of the optical functional layer in a manner that the electric field oscillating surface of the liner-polarized light coincides with the parallel direction to and the perpendicular direction to the thickness direction. Each Raman scattering spectrum is measured regarding the parallel direction to and the perpendicular direction to the thickness direction of the cross-section in the thickness direction. Subsequently, a peak intensity at 1605 cm⁻¹ (peak derived by C—H binding) and a peak intensity at 2942 cm⁻¹ (peak derived by benzene ring) are evaluated and the Raman peak intensity is obtained. The Raman spectrum is measured using the laser Raman spectrophotometer and under conditions of: 15 seconds of exposing time, 8 times of integrating time and 532.11 nm in excitation wavelength.

The Raman peak intensity of the optical functional layer is obtained by, for example, cutting the optical functional layer in the thickness direction to produce a piece and by measuring a Raman scattering spectrum only of a part corresponding to the optical functional layer.

The optical functional film of the present invention comprises, as mentioned above, the substrate and the optical functional layer formed directly on the substrate. Hereinafter, each constitution of the optical functional film of the present invention will be explained in detail.

### 1. Optical Functional Layer

First, an optical functional layer constituting the optical functional film of the present invention will be explained. The optical functional layer of the present invention is formed directly on the substrate to be explained later and contains rodlike compounds forming the irregular-random homogeneous alignment.

### (1) Rodlike Compound

The rodlike compound used in the present invention will be explained. The rodlike compound used in the present invention is not particularly limited, so long as it can form the irregular-random homogeneous alignment in the optical functional layer and exhibits refractive index anisotropic property in the molecule.

Here, the “rodlike compound” in the present invention means a compound in which a main skeleton of the molecular structure is rod-like. As the compound having such rod-like main skeletons, mention may be made of azomethin compounds, azoxy compounds, cyanobiphenyl compounds, cyanophenyl esters, benzoic acid esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenylcyclohexyl benzonitriles. Further, not only the above-mentioned low-molecular liquid crystalline compounds but also high-molecular liquid crystalline compounds can be used.

Any rodlike compound of the above-mentioned type can be used suitably in the present invention. Among the above, the rodlike compound is preferably the one having a rodlike-main skeleton having plural benzene rings and particularly preferable is the one with a rodlike-main skeleton having plural benzene rings bound by ester. This is because rodlike compounds having such structure exhibits large refractive index anisotropy in their molecules so that they can provide high retardation properties to the optical functional layer by aligning in the optical functional layer.

As the rodlike compound used in the present invention, a compound having a relatively small molecular weight is favorably used. More specifically, a compound having a molecular weight in the range of 200 to 1200, particularly in the range of 400 to 800 is favorably used. This is because, when the molecular weight is in the above-mentioned range, the rodlike compound is likely to be penetrated into the substrate mentioned later. Consequently, a “mixed” state is likely to be formed at the bonding position between the substrate and the optical functional layer, and the adhesion property between the substrate and the optical functional layer can be improved.

As to the above-mentioned molecular weight concerning the rodlike compound of the optical functional layer which is a material having a polymerizable functional group to be described later, it refers to the molecular weight before the polymerization.

Moreover, it is preferable that the rodlike compound used in the present invention is a liquid crystalline material showing the liquid crystalline property. Since the rodlike compound is a liquid crystalline material, the above optical functional layer can be provided with the excellent optical characteristic realizing property per unit thickness. Moreover, it is preferable that the rodlike compound used in the present invention is a liquid crystalline material showing the nematic phase among the liquid crystalline materials. A liquid crystalline material showing the nematic phase can form the irregular-random homogeneous alignment relatively easily.

Furthermore, it is preferable that the above liquid crystalline material showing the nematic phase is a molecule having a spacer on both ends of the mesogen. Since a liquid crystalline material having a spacer on both ends of the mesogen has the excellent flexibility, clouding of the optical functional layer in the present invention can effectively be prevented.

As the rodlike compound used in the present invention, those having a polymerizable functional group in a molecule can be used preferably. In particular, those having a three-dimensionally cross-linkable polymerizable functional group are preferable. Since the rodlike compound has a polymerizable functional group, the rodlike compound can be fixed by the polymerization. By fixing the rodlike compound in a state where the irregular-random homogenous alignment is formed, an optical functional film having the sequence stability and having difficulty in causing changes in optical characteristics can be obtained. In the present invention, the above-mentioned rodlike compound having a polymerizable functional group and the above-mentioned rodlike compound not having a polymerizable functional group can be used as a mixture.

The “three-dimensional cross-linking” mentioned above denotes to three-dimensionally polymerize the liquid crystalline molecules with each other so as to be in a mesh-like (network) structure state.

As the polymerizable functional group, various polymerizable functional groups to be polymerized by the function of the ionizing radiation such as the ultraviolet ray and the electron beam, or the heat can be used without particular limitation. As the representative examples of these polymerizable functional groups, a radically polymerizable functional group, or a cation polymerizable functional group can be presented. Furthermore, as the representative examples of the radically polymerizable functional group, a functional group having at least one addition polymerizable ethylenically unsaturated double bond can be presented. As the specific examples, a vinyl group having or not having a substituent, or an acrylate group (the general term including an acryloyl group, a methacryloyl group, an acryloyloxy group, and a methacryloyloxy group) can be presented. Moreover, as the specific examples of the cation polymerizable functional group, an epoxy group, or the like can be presented. Additionally, as the polymerizable functional group, for example, an isocyanate group or an unsaturated triple bond can be presented. Among these examples, in terms of the process, a functional group having an ethylenically unsaturated double bond can be used preferably.

As the rodlike compound in the present invention, a liquid crystalline material showing the liquid crystalline property, having the above-mentioned polymerizable functional group on the end is particularly preferable. For example, by using a nematic liquid crystalline material having a polymerizable functional group on the both ends, a mesh-like (network) structure state can be provided by the three-dimensional polymerization with each other so as to obtain an optical functional layer having the sequence stability and excellent optical characteristic realizing properties. Moreover, even in the case of one having a polymerizable functional group on one end, it can have the sequence stability by cross-linking with the other molecules. As such a rodlike compound, the compounds represented by the following formulae (1) to (6) can be presented.

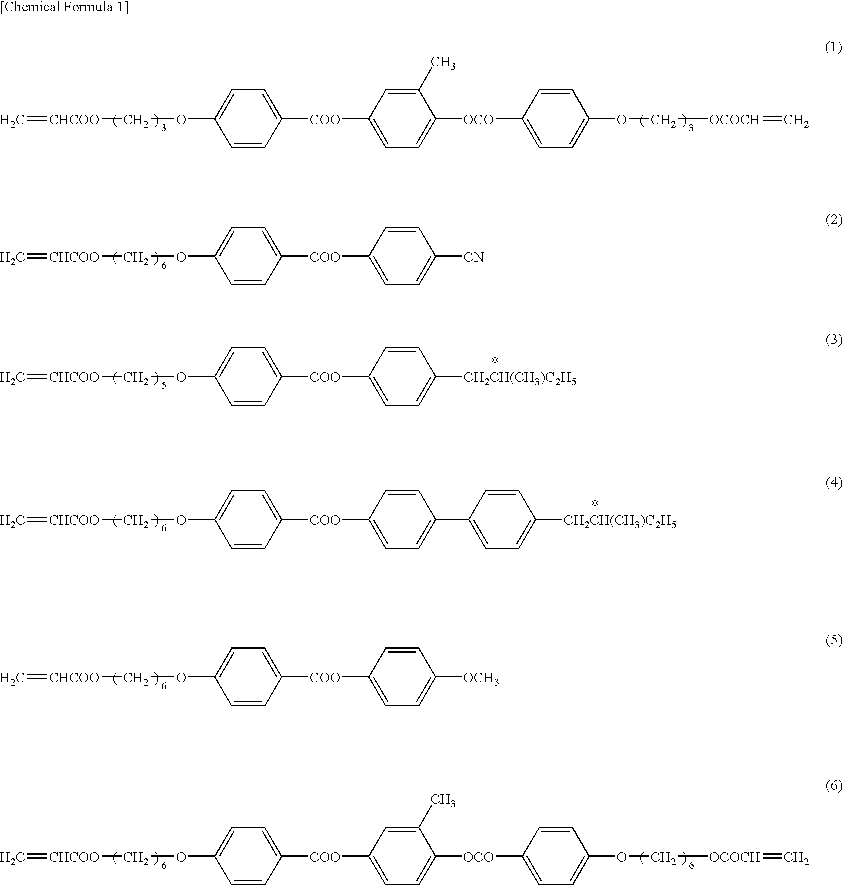

Here, the liquid crystalline materials represented by the chemical formulae (1), (2), (5) and (6) can be prepared according to the methods disclosed by D. J. Broer et, al., Makromol. Chem. 190, 3201-3215 (1989), or by D. J. Broer et, al., Makromol. Chem. 190, 2250 (1989), or by a similar method. Moreover, preparation of the liquid crystalline materials represented by the chemical formulae (3) and (4) is disclosed in DE 195,04,224.

Moreover, as the specific examples of the nematic liquid crystalline material having an acrylate group on the end, those represented by the following chemical formulae (7) to (17) can also be presented.

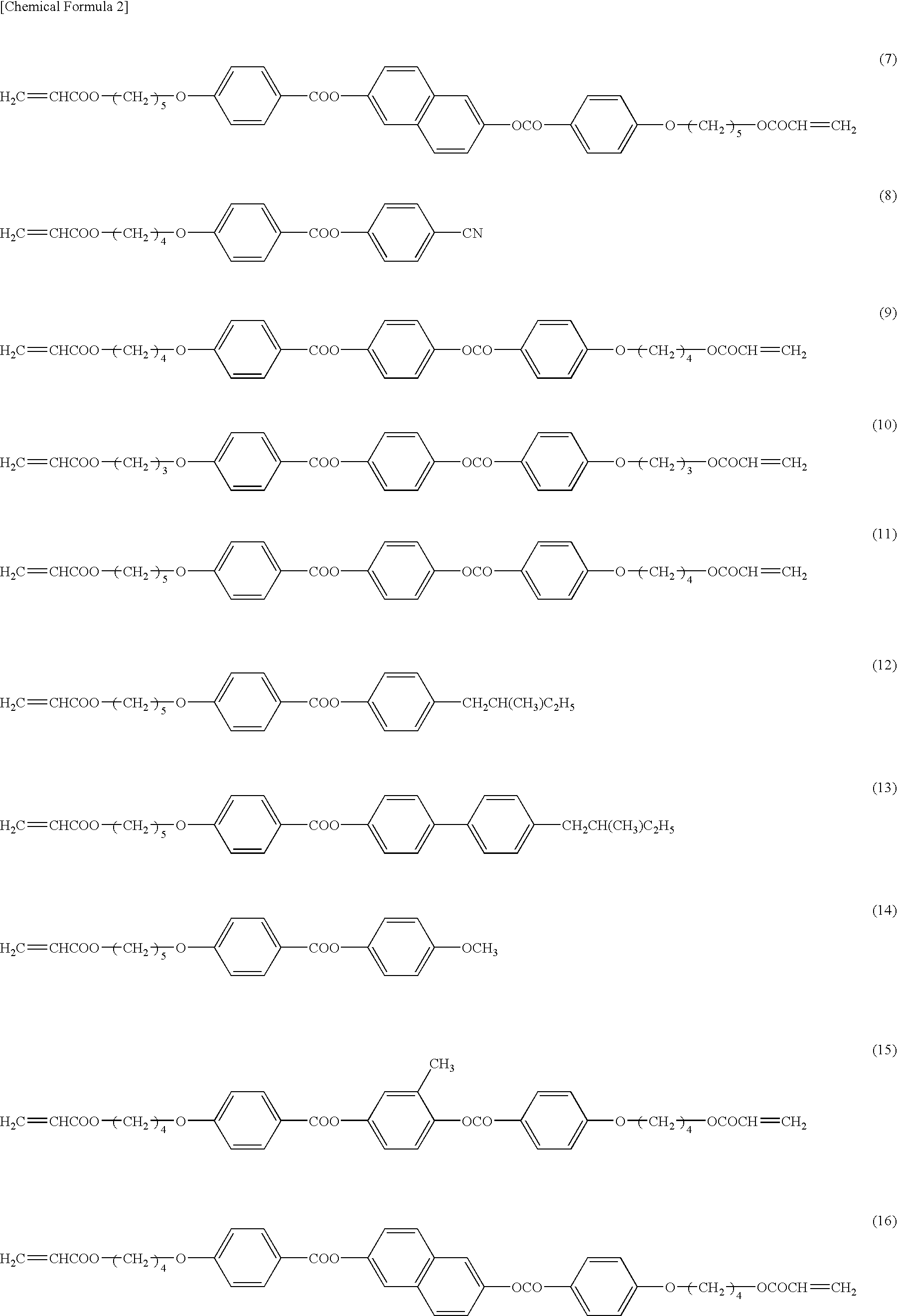

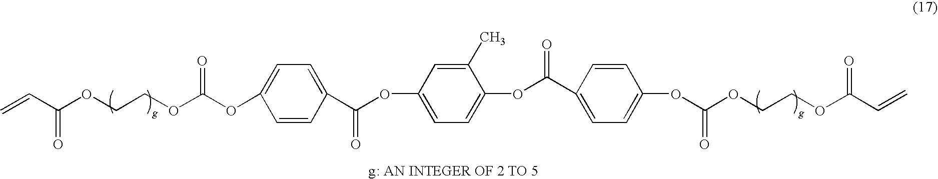

In the present invention, as the rodlike compound, only one kind may be used, or two or more kinds may be used as a mixture.

For example, when a mixture of a liquid crystalline material having one or more polymerizable functional groups on the both ends and a liquid crystalline material having one or more polymerizable functional groups on one end is used, it is preferable because the polymerization density (cross-linking density) and the optical characteristics can be adjusted optionally by adjusting the composition ratio thereof.

### (2) Other Compounds

In the optical functional layer in the present invention, other compound(s) may be included besides the above-mentioned rodlike compound. Such other compound is not particularly limited, so long as it does not disturb the irregular-random homogeneous alignment of the rodlike compound. As such other compound, a polymerizable material ordinarily used in a hard coat agent can be given, for example.

As the above polymerizable material, mention may be made, for example, of a polyester (metha)acrylate obtained by reacting (metha)acrylic acid with a polyester prepolymer which is obtained by condensing a polyvalent alcohol with a monobasic acid or a polybasic acid; a polyurethane (metha)acrylate obtained by mutually reacting a compound having a polyol group and a compound having two isocyanate groups and then reacting the reaction product thereof with (metha)acrylic acid; photopolymerizable compounds, such as epoxy (metha)acrylates, obtained by reacting (metha)acrylic acid with an epoxy resin such as a bisphenol A type epoxy resin, a bisphenol F type epoxy resin, a novolac type epoxy resin, a polycarboxylic acid polyglycidyl ester, polyol polyglycidyl ether, an aliphatic or alicyclic epoxy resin, an amino group epoxy resin, a triphenol methane type epoxy resin or a dihydroxy benzene type epoxy resin; and a photopolymerizable liquid crystalline compound having an acrylic group or a methacrylic group.

### (3) Optical Functional Layer

The optical functional layer of the present invention is preferably formed directly on the substrate to be explained later. By forming the optical functional layer directly on the substrate, the optical functional film of the present invention can have excellent adhesion property between the optical functional layer and the substrate.

It is considered that the formation of the optical functional layer directly on the substrate like this improves the adhesion force between them through the following mechanism. That is, since the formation of the optical functional layer directly on the substrate enables the rod-like molecules contained in the optical functional layer to be penetrated into the substrate from the surface thereof, or since a solvent used at the time of forming the optical functional layer enables the surface of the substrate to be dissolved depending on the kind of the solvent and thereby allows the rod-like compound and the substrate to mix, there is no clear interface at a bonding portion between the substrate and the optical functional layer, and the bonding portion is in a “mixed” state of them. Thus, it is considered that the adhesion property is conspicuously improved owing to this as compared with the bonding through the conventional interface interaction.

In addition, the conventional optical functional film with the alignment layer has the problem that light undergoes multiple reflections in the interface between the alignment layer and the optical functional layer and the interface between the alignment layer and the substrate to cause interference fringes. However, according to the optical functional film of the present invention, there is no clear interface, because the film has no alignment layer and the bonding portion between the substrate and the optical functional layer is in the “mixed” state. Therefore, the optical functional film of the present invention has the merits that the above-mentioned multiple reflections do not occur and therefore, the deterioration in quality does not occur owing to the interference fringes.

The thickness of the optical functional layer in the present invention is not particularly limited, so long as it is in the range in which desired optical characteristics can be imparted upon the optical functional layer, depending upon the kind of the rodlike compound. Particularly, in the present invention, the thickness of the optical functional layer is preferably in the range of 0.5 μm to 10 μm, more preferably in the range of 0.5 μm to 5 μm, and particularly preferably in the range of 1 μm to 3 μm. If the thickness of the optical functional layer is greater than the above-mentioned range, it may be that the “in-plane alignment properties” as one of the features of the irregular-random homogeneous alignment is damaged, so that the desired optical characteristics are not obtained. If the thickness is smaller than the above-mentioned range, it may also be that the targeted optical characteristics are not obtained depending upon the kind of the rodlike compound.

From the standpoint of the “anisotropy” and the “in-plane alignment properties” possessed by the above-mentioned irregular-random homogeneous alignment, as mentioned above, the retardation (Re) of the optical functional layer in the present invention is preferably in the range of 5 nm to 300 nm, more preferably in the range of 10 nm to 200 nm, and particularly preferably in the range of 40 nm to 150 nm. Here, the definition and the measuring method of the Re value are as mentioned above, and thus explanation is omitted here.

Furthermore, as to the optical functional layer in the present invention, the value (Re/d) obtained by dividing the retardation value (Re (nm)) of the optical functional layer by the thickness “d” (μm) of the optical functional layer is preferably in the range of 0.5 to 600, more preferably in the range of 2 to 400, and particularly preferably in the range of 13 to 150.

From the standpoint of the “in-plane alignment properties” possessed by the irregular-random homogeneous alignment, as mentioned above, the retardation in the thickness direction (Rth) of the optical functional layer in the present invention is preferably in the range of 50 nm to 400 nm, more preferably in the range of 75 nm to 300 nm, and particularly preferably in the range of 100 nm to 250 nm. Here, the definition and the measuring method of the Rth value are as mentioned above, and thus explanation is omitted here.

Meanwhile, as to the optical functional layer in the present invention, the value (Rth/d) which is obtained by dividing the retardation value in the thickness direction (Rth (nm)) of the optical functional layer by the thickness (d (μm)) of the optical functional layer is preferably in the range of 5 to 800, more preferably in the range of 15 to 600, and particularly preferably in the range of 33 to 250.

From the standpoint of the “dispersibility” possessed by the irregular-random homogeneous alignment, as mentioned above, the haze of the optical functional layer in the present invention is preferably in the range of 0% to 5%, more preferably in the range of 0% to 1%, and particularly preferably in the range of 0% to 0.5%. Here, the definition and the measuring method of the haze are as mentioned above, and thus explanation is omitted here.

The configuration of the optical functional layer in the present invention is not limited to a single layer structure, but the optical functional layer may have a configuration in which a plurality of layers is laminated. In the case of the configuration in which the plural layers are laminated, the layers having the same composition may be laminated, or the plural layers having different compositions may be laminated. Further, in the case of the configuration in which the optical functional layer is composed of the plural layers, at least the optical functional layer laminated directly on the substrate has only to possess the rodlike compound forming the irregular-random homogeneous alignment.

### 2. Substrate

Next, a substrate used in the present invention will be explained. A substrate which has optional optical characteristics according to the optical characteristics required for the optical functional film of the present invention can be used for the substrate of the present invention. In particular, the substrate of the present invention is preferably the one: which realizes the relation: nx≠ny among a refractive index “nx” in a slow axis direction of an in-plane direction, and a refractive index “ny” in a fast axis direction of an in-plane direction; or which realizes the relation: nx≠ny≠nz among a refractive index “nx” in a slow axis direction of an in-plane direction, a refractive index “ny” in a fast axis direction of an in-plane direction, and the refractive index “nz” in a thickness direction.

Here, when the relation: nx≠ny is realized among the above-mentioned “nx” and “ny”, the substrate has a property as an optically A-plate. Alternatively, when the relation: nx≠ny≠nz is realized among the above-mentioned “nx”, “ny” and “nz”, the substrate has a property as an optically B-plate, that is to exhibit optical biaxiality. The “property as an optically B-plate” denotes specifically to a state where the relation: Rth≠(Re/2) is realized.

The above-mentioned relation: nx≠ny≠nz covers a state where the relation: nx≠ny, ny≠nz and nz≠nx are realized.

A value of the in-plane retardation (Re) of the substrate of the present invention is preferably within the range of 5 nm to 300 nm, more preferably within the range of 10 nm to 200 nm, and most preferably within the range of 40 nm to 150 nm. This is because, when the value of the in-plane retardation (Re) of the substrate is in the above-mentioned range, the irregular-random homogeneous alignment is easily formed in the optical functional layer, irrespective of the kind of the rodlike compound.

Here, the measuring method of the Re of the substrate is identical with that explained as the measuring method of the Re in the optical functional layer, and thus explanation thereof is omitted here.

In addition, from the standpoint of the formation of the irregular-random homogeneous alignment having the uniform quality, the value of Re is in the above-mentioned range, and the value of the retardation in a thickness direction (Rth) is preferably in the range of 2.5 nm to 150 nm, particularly preferably in the range of 5 nm to 100 nm, and more preferably in the range of 20 nm to 75 nm.

Here, the definition and the measuring method of the Rth are identical with those explained in the above section “1. Optical functional layer”, and thus explanation thereof is omitted here.

The transparency of the substrate used in the present invention may be determined optionally according to factors such as the transparency required to the optical functional film of the present invention. In general, it is preferable that the transmittance in a visible light zone is 80% or more, and it is more preferably 90% or more. This is because, if the transmittance is low, the selection ranges in the rodlike compound and the like becomes narrow. Here, the transmittance of the substrate can be measured according to the JIS K7361-1 (Testing method of the total light transmittance of a plastic-transparent material).

The thickness of the substrate used in the present invention is not particularly limited as long as necessary self supporting properties can be obtained according to factors such as the application of the optical functional film of the present invention. In general, it is preferably in the range of 10 μm to 188 μm; it is more preferably in the range of 20 μm to 125 μm; and it is particularly preferably in the range of 30 μm to 80 μm. In the case the thickness of the substrate is thinner than the above-mentioned range, the necessary self supporting properties may not be provided to the optical functional film of the present invention. Moreover, in the case the thickness is thicker than the above-mentioned range, for example, at the time of cutting process of the optical functional film of the present invention, the process waste may be increased or wear of the cutting blade may be promoted.

As the substrate used in the present invention, either a flexible material having the flexible property or a rigid material without the flexible property can be used as long as it has the above-mentioned optical characteristics, however, it is preferable to use a flexible material. Since the flexible material is used, the production process for the optical functional film of the present invention can be provided as a roll-to-roll process so that an optical functional film having excellent productivity can be obtained.

As the material for the above-mentioned flexible material, cellulose derivatives, a norbornen based polymer, polymethyl methacrylate, polyvinyl alcohol, polyimide, polyallylate, polyethylene terephthalate, polysulfone, polyether sulfone, amorphous polyolefin, a modified acrylic based polymer, polystyrene, an epoxy resin, polycarbonate, polyesters, or the like can be presented. Among them, cellulose derivatives or the norbornen based polymer can be used preferably.

As the cellulose derivatives used in the present invention, cellulose esters can be used preferably. Furthermore, among the cellulose esters, it is preferable to use cellulose acylates. Since the cellulose acylates are used widely in the industrial field, it is advantageous in terms of the availability.

As the cellulose acylates, lower fatty acid esters having 2 to 4 carbon atoms are preferable. The lower fatty acid ester may be one including a single lower fatty acid ester such as a cellulose acetate, or it may be one including a plurality of lower fatty acid esters such as a cellulose acetate butylate and a cellulose acetate propionate.

In the present invention, among the above-mentioned lower fatty acid esters, a cellulose acetate can be used particularly preferably. As the cellulose acetate, it is most preferable to use triacetyl cellulose having the average acetification degree of 57.5 to 62.5% (substitution degree: 2.6 to 3.0). Since triacetyl cellulose has the molecular structure having relatively bulky side chains, when the substrate is made of the triacetyl cellulose, the rodlike compound forming the optical functional layer is likely to penetrate into the substrate, and thus the adhesion property between the substrate and the optical functional layer can be further improved. In addition, since triacetyl cellulose readily exhibits the property as the optically negative C-plate, the random homogeneous alignment of the rodlike compound is easily formed. Here, an acetification degree means an amount of bonded acetic acid per unit mass of cellulose. The acetification degree can be determined through measurement and calculation of the acetification degree in ASTM: D-817-91 (a testing method for cellulose acetate, etc). Note that the acetification degree of triacetyl cellulose constituting the triacetyl cellulose film can be determined by the above-mentioned method after impurities such as a plasticizer contained in the film are removed.

As the norbornen based polymer, a cycloolefin polymer (COP) and a cycloolefin copolymer (COC) can be presented. In the present invention, it is preferable to use a cycloolefin polymer. Since the cycloolefin polymer has low absorbing properties and transmitting properties of the moisture content, by using the substrate made of the cycloolefin polymer in the present invention, the optical functional film of the present invention can be provided with the excellent temporal stability in the optical characteristics.

As the substrate used for the present invention, either of one made of the cellulose derivative and one made of the norbornen based polymer can be used suitably. In particular, a substrate made of the cellulose derivatives is preferably used as the substrate of the present invention. By using a cellulose derivative having excellent moisture permeability as the substrate, moisture contained in a polarizer can be volatilized through a film during the production process when, for example, a polarizing plate is produced using the optical functional film of the present invention. Further, this is also because such substrate is excellent in yield since the substrate has excellent adhesion property to a polarizing film which contains PVA as a main material, and requires no liner unlike a norbornene resin so that it has less problem concerning foreign matters.

The configuration of the substrate in the present invention is not limited to a single layer configuration, but it may have a configuration in which a plurality of layers is laminated. When the substrate has the configuration in which a plurality of the layers is laminated, the layers having the same composition may be laminated, or the plural layers having different compositions may be laminated.

As the configuration of the substrate in which the plural layers having the different compositions are laminated, for example, a configuration is given by example, in which a supporting body having excellent moisture permeability and self-supporting property is laminated upon a film made of a material, such as triacetyl cellulose, to make the rodlike compound form the irregular-random homogeneous alignment.

### 3. Optical Functional Film

Since one of the features of the optical functional film of the present invention is that the optical functional layer is formed directly on the substrate, the rodlike compound contained in the optical functional layer penetrates into the above substrate, and the mixed region where both are “mixed” is formed at the bonding portion between the substrate and the optical functional layer. The thickness of such a mixed region is not particularly limited, so long as the above irregular-random homogeneous alignment can be formed, and the adhesion force between the substrate and the optical functional layer can be set in a desired range. Especially, in the present invention, the thickness of the mixed region is preferably in the range of 0.1 μm to 10 μm, particularly preferably in the range of 0.5 pin to 5 μm, and most preferably in the range of 1 μm to 3 μm in that range.

The distributed state of the rodlike compound in the mixed region is not particularly limited, either, so long as the irregular-random homogeneous alignment can be formed, and adhesion force between the substrate and the optical functional layer can be set in a desired range. As the above distributed state of the rodlike compound, a configuration in which the rodlike compound exists uniformly in the thickness direction of the substrate and a configuration in which the rodlike compound has a concentration gradient in the thickness direction of the substrate are given by way of example. Either of the configurations can be favorably used in the present invention.

Meanwhile, the confirmation of the presence of the mixed region and the confirmation of the distributed state of the rodlike compound in the mixed region can be made by a TOF-SIMS method.

The optical functional film of the present invention may have other configurations other than the substrate and the optical functional layer. As the other configurations, for example, a reflection preventing layer, an ultraviolet ray absorbing layer, an infrared ray absorbing layer, or a charge preventing layer can be presented.

The reflection preventing layer used in the present invention is not particularly limited. For example, one comprising a low refractive index layer formed on a transparent substrate film, in which the layer made of a substance having a refractive index lower than that of the transparent substrate is formed; or one comprising a high refractive index layer made of a substance having a refractive index higher than that of the transparent substrate and a low refractive index layer made of a substance having a refractive index lower than that of the transparent substrate formed in this order alternately by each one or more layers on a transparent substrate film can be presented. These high refractive index layer and the low refractive index layer are formed such as by vacuum vapor deposition or coating so as to have the optical thickness represented by the multiple of the geometric thickness and the refractive index by ¼ of the wavelength of the light beam to have the reflection prevention. As the constituent material for the high refractive index layer, titanium oxide, zinc sulfide, or the like; as the constituent material for the low refractive index layer, magnesium fluoride, cryolite, or the like can be used.

Moreover, the ultraviolet ray absorbing layer used in the present invention is not particularly limited. For example, a film formed by adding an ultraviolet ray absorbing agent made of such as a benzotriazol based compound, a benzophenone based compound, or a salicylate based compound in a film of such as a polyester resin or an acrylic resin can be presented.

Further, the infrared ray absorbing layer used in the present invention is not particularly limited. For example, one formed by such as coating an infrared ray absorbing layer on a film substrate of a polyester resin can be presented. As the infrared ray absorbing layer, for example, one formed by adding an infrared ray absorbing agent made of such as a diimmonium based compound or a phthalocyanine based compound in a binder resin made of such as an acrylic resin or a polyester resin can be used.

Still Further, as the charge preventing layer used in the present invention, for example, various kinds of cation charge preventing agents having a cation group such as quaternary ammonium salt, pyridinium salt, and primary to tertiary amino salts; anion charge preventing agents having an anion group such as a sulfonic acid base, an ester sulfide base, an ester phosphate base, and a phosphoric acid base; amphoteric charge preventing agents of such as the amino acid based, and the amino ester sulfide based; nonion charge preventing agents of such as the amino alcohol based, the glycerin based, and the polyethylene glycol based; polymer type charge preventing agents with the above-mentioned charge preventing agents provided with a high molecular weight; those formed as a film by adding a charge preventing agent, for example, a polymerizable charge preventing agent such as a monomer or an oligonomer having a tertiary amino group or a quaternary ammonium group and to be polymerized by the ionizing radiation, such as N,N-dialkyl amino alkyl (meth)acrylate monomer and a quaternary compound thereto can be presented.

The thickness of the optical functional film of the present invention is not particularly limited, so long as it can exhibit the desired optical characteristics. Ordinarily, the thickness is preferably in the range of 10 μm to 200 μm, and more preferably in the range of 20 μm to 135 μm, and most preferably in the range of 30 μm to 90 μm.

Meanwhile, the haze value of the optical functional film of the present invention as measured according to the JIS K7105 is preferably in the range of 0% to 5%, particularly preferably in the range of 0% to 1%, and most preferably in the range of 0% to 0.5%.

Further, a value of the retardation in a thickness direction (Rth) of the optical functional film of the present invention is preferably in the range of 50 nm to 400 nm, more preferably in the range of 75 nm to 300 nm, and most preferably in the range of 100 nm to 250 nm. Moreover, a value in the in-plane retardation (Re) is preferably in the range of 5 nm to 300 nm, more preferably in the range of 10 nm to 200 nm, and most preferably in the range of 40 nm to 150 nm.

Since values of the Re and the Rth is in the above-mentioned range, the optical functional film produced by the present invention can be used as a retardation film suitable for improving the viewing angle characteristics of the liquid crystal display.

Here, the definition and the measuring method of the Re value and Rth value are identical with those explained above, and thus explanation is omitted here.

The above-mentioned in-plane retardation (Re) value and the retardation in a thickness direction (Rth) value may have the wavelength dependency. For example, the wavelength dependency may be in a reverse dispersion mode in which a value is greater on the longer wavelength side than on the shorter wavelength side, or in a normal dispersion mode in which a value is greater on the shorter wavelength side than on the longer wavelength side. This is because, by having such wavelength dependency, viewing angle properties of the liquid crystal display can be improved in the whole range of the visual light zone when the optical functional film of the present invention is used as a retardation film to improve viewing angle properties of the liquid crystal display.

In the present invention, wavelength dispersion of the substrate and that of the optical functional layer may be the same or different.

Meanwhile, as to the optical functional layer in the present invention, the value (Rth/d) which is obtained by dividing the retardation value in the thickness direction (Rth (nm)) by the thickness (d (μm)) is preferably in the range of 0.25 to 40, more preferably in the range of 0.6 to 15, and most preferably in the range of 1.1 to 8.3.

As to the optical functional layer in the present invention, the value (Re/d) which is obtained by dividing the retardation value of in-plane retardation (Re (nm)) by the thickness (d (μm)) is preferably in the range of 0.025 to 30, more preferably in the range of 0.05 to 10, and particularly preferably in the range of 0.44 to 5.

### 4. Applications of the Optical Functional Film

The application of the optical functional film of the present invention is not particularly limited, and it can be used as the optical functional film for various applications. As the concrete application of the optical functional film of the present invention, for example, an optical compensator (for example, a viewing angle compensator), an elliptical polarizing plate, and a luminance improving plate used in the liquid crystal displays can be cited. Particular, in the present invention, the optical functional film can be used in the application as the B-plate. When the optical functional film is used as the optical compensator as the B-plate in this manner, it can be favorably used in a liquid crystal display having a liquid crystal layer with a VA mode, an OCB mode or the like.

Further, the optical functional film of the present invention can also be used as an optical compensating plate having a property of optically A-plate. In liquid crystal displays of IPS (In-plane Switching) system, retardation films having properties of A-plate and positive C-plate are used. By controlling the values of the in-plane retardation (Re) and the retardation in a thickness direction (Rth) and making the relation among the refractive indexes closer to the relation: nx≧ny>nz, the optical functional film of the present invention can be used as a retardation film having a property of A-plate which is used for liquid crystal displays of IPS system.

In addition, when the optical functional film of the present invention is bonded to a polarizing layer, they can be used as a polarizing film. The polarizing film ordinarily comprises a polarizing layer and protective layers formed on opposite surfaces thereof. In the present invention, for example, when one of the protective layers is made of the above-mentioned optical functional film, a polarizing film having an optical compensation function to improve the viewing angle characteristics of the liquid crystal display can be obtained, for example.

Although not limited, as the above polarizing layer, an iodine based polarizing layer, a dye based polarizing layer using a dichromatic dye, and a polyene based polarizing layer can be used, for example. The iodine based polarizing layer and the dye based polarizing layer are generally produced by using polyvinyl alcohol.

### 5. Producing Method of the Optical Functional Film

The producing method of the optical functional film of the present invention is not particularly limited as long as it can produce the optical functional film having the above-mentioned constitution. The optical functional film of the present invention can be produced by, for example, the method described in the “B. Producing method of the optical functional film” to be mentioned below.

### B. Producing Method of the Optical Functional Film

Next, a producing method of the optical functional film of the present invention will be explained. The production method of an optical functional film of the present invention comprises: a substrate which realizes the relation: nx≠ny or nx≠ny≠nz among a refractive index “nx” in a slow axis direction of an in-plane direction, a refractive index “ny” in a fast axis direction of an in-plane direction, and a refractive index “nz” in a thickness direction; and an optical functional layer formed on the substrate, in which the optical functional layer exhibits optical biaxiality and contains a rodlike compound forming irregular-random homogeneous alignment, characterized in that the production method comprises a step of stretching an optical film which comprises: a substrate having at least a property as an optically negative C-plate; and an optical functional layer formed directly on the substrate, in which the optical functional layer exhibits optical uniaxiality and contains a rodlike compound forming random homogeneous alignment.

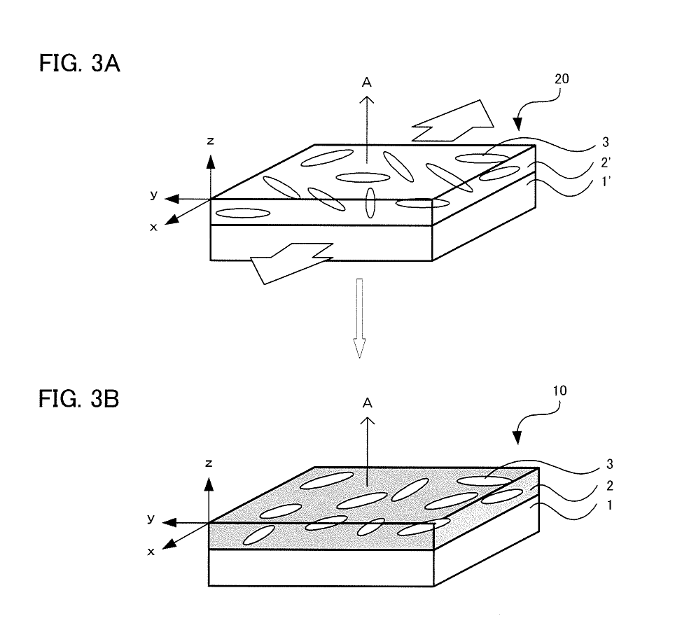

Next, the producing method of the optical functional film of the present invention will be explained with a reference to the drawings. FIGS. 3A and 3B are each a schematic view showing one example of the producing method of the optical functional film of the present invention. As shown in FIGS. 3A and 3B, the production method of an optical functional film is as follows. The optical film 20 which comprises: a substrate 1′ having at least a property as an optically negative C-plate; and an optical functional layer 2′, formed on the substrate 1′, which exhibits optical uniaxiality and contains a rodlike compound 3 forming random homogeneous alignment (FIG. 3A) is used. The optical film 20 is stretched to X-direction (FIG. 3B), and thereby the optical functional film 10 is obtained, wherein the optical functional film 10 comprises: the substrate 1 which realizes the relation: nx≠ny or nx≠ny≠nz among a refractive index “nx” in a slow axis direction of an in-plane direction, a refractive index “ny” in a fast axis direction of an in-plane direction, and a refractive index “nz” in a thickness direction; and the optical functional layer 2, formed on the substrate 1, which exhibits optical biaxiality and contains the rodlike compound 3 forming irregular-random homogeneous alignment.

In the present invention, by using an optical film which comprises: a substrate having at least a property as an optically negative C-plate; and an optical functional layer, formed directly on the substrate, which exhibits optical uniaxiality and contains a rodlike compound forming random homogeneous alignment, and by stretching the optical film, the substrate realizes the relation: nx≠ny or nx≠ny≠nz among a refractive index “nx” in a slow axis direction of an in-plane direction, a refractive index “ny” in a fast axis direction of an in-plane direction, and a refractive index “nz” in a thickness direction.

Further, since the above-mentioned random homogeneous alignment is changed into the irregular-random homogeneous alignment by stretching, the optical functional film can be provided with optical biaxiality.

Thereby, in the present invention, the optical functional film is easily formed, wherein the optical functional film comprises: a substrate which realizes the relation: nx≠ny or nx≠ny≠nz among a refractive index “nx” in a slow axis direction of an in-plane direction, a refractive index “ny” in a fast axis direction of an in-plane direction, and a refractive index “nz” in a thickness direction; and an optical functional layer formed on the substrate, in which the optical functional layer exhibits optical biaxiality and contains a rodlike compound forming irregular-random homogeneous alignment. Accordingly, optical functional film having a high degree of design freedom in optical characteristics can be produced simply.

Hereinafter, the producing method of the optical functional film of the present invention will be explained in detail.

### 1. Optical Film

First, an optical film used in the producing method of the optical functional film of the present invention will be explained. The optical film used in the present invention comprises a substrate having at least a property as an optically negative C-plate; and an optical functional layer formed directly on the substrate, in which the optical functional layer exhibits optical uniaxiality and contains a rodlike compound forming random homogeneous alignment.

### (1) Substrate

The substrate used for the optical film has at least a property as an optically negative C-plate and functions as a so-called alignment layer for making the rodlike compound form random homogeneous alignment.

The substrate used for the optical film of the present invention is not particularly limited, so long as it has the property as the optically negative C-plate. Here, that “has the property as the optically negative C-plate” in the present invention means that the relation: nx=ny>nz, nx>ny>nz or ny>nx>nz is satisfied in which “nx” and “ny” are respectively the refractive indexes in arbitrary X-direction and Y-direction which is perpendicular to the X-direction of in-plane of the substrate sheet, and “nz” is the refractive index in the thickness direction.

The substrate having the property as the optically negative C-plate is used as the substrate for the optical film because of the following reason. That is, as mentioned above, the substrate in the present invention functions as the so-called alignment film for making the rodlike compound form the random homogeneous alignment. If the substrate does not have the property as the optically negative C-plate, the rodlike compound cannot form the random homogeneous alignment.

In the present invention, the mechanism in which the rodlike compound forms the random homogeneous alignment when the optical functional layer containing the rodlike compound is formed on the substrate having the property as the optically negative C-plate is not clear. But, this is considered to be based on the following mechanism.

That is, for instance, if a case of the substrate being made of a polymer material is considered, it is thought that when the substrate has the property as the optically negative C-plate, most of the polymer material constituting the substrate is aligned random, without specific regularity, in the in-plane direction. It is thought that when the above rodlike compound is applied onto the substrate having most of the polymer material aligned randomly in the in-plane direction on the surface, the rodlike compound partially penetrates into the substrate, and the molecular axes are aligned along those molecular axes of the polymer material which are aligned randomly. It is thought that such a mechanism makes the substrate having the optically negative C-plate exhibit the function as the alignment film to form the random homogeneous alignment.

It is considered that the substrate has the function as the alignment film for making the rodlike compound form the random homogeneous alignment through the above-mentioned mechanism. Therefore, the substrate used for the optical film must have alignment controlling power for the rodlike compound, and must take a configuration in which that material constituting the substrate which exhibits the property as the optically negative C-plate must be present at the surface of the substrate. Accordingly, even if the substrate has the property as the optically negative C-plate, that configuration cannot be used as the substrate of the optical film, in which when the optical functional layer is formed on the substrate, the above rodlike compound cannot contact that material constituting the substrate which has the alignment controlling power for the rodlike compound.

As such a substrate being unable to be used for the optical film, for example, mention may be made of a substrate having a configuration that a supporting body having a construction made of a polymer material alone and having the property as the optically negative C-plate is laminated with a retardation layer containing an optically anisotropic material with a refractive index anisotropic property. In the substrate having such a configuration, the polymer material constituting the supporting body is that material constituting the substrate which has the alignment controlling power to the above rodlike compound. However, when the above optical functional layer is formed on the retardation layer, the rodlike compound cannot contact the polymer material due to the presence of the retardation layer. Therefore, the substrate having such a configuration is not included in the substrate, in the present invention, even having the property as the optically negative C-plate.

The property of the optically negative C-plate of the substrate used for the optical film may be appropriately selected depending upon factors such as the kind of the rodlike compound used in the above optical functional layer, and the optical characteristics required for the optical functional film produced in the present invention. Especially, in the present invention, the retardation in the thickness direction (Rth) of the substrate is preferably in the range of 2.5 nm to 150 nm, particularly preferably in the range of 5 nm to 100 nm, and most preferably in the range of 20 nm to 75 nm. This is because, when the retardation in the thickness direction (Rth) of the substrate is in the above range, the random homogeneous alignment is easily formed in the optical functional layer, irrespective of the kind of the rodlike compound. Further, when the Rth of the substrate is in the above range, the random homogeneous alignment having a uniform quality can be formed.

Here, the definition and the measuring method of the Rth are identical with those explained in the above section “A. Optical functional film”, and thus explanation thereof is omitted here.

From the standpoint of the formation of the random homogeneous alignment having the uniform quality, in addition to the Rth of the above-mentioned range, the in-plane retardation (Re) is preferably in the range of 0 nm to 300 nm, more preferably in the range of 0 nm to 150 nm, and most preferably in the range of 0 nm to 125 nm.

Here, the transparency and thickness of the substrate used for the optical film are identical with those explained in the above section “A. Optical functional film”, and thus explanation thereof is omitted here.

Further, materials constituting the substrate used for the optical film are not particularly limited as long as they have the above-mentioned optical characteristics. Specific materials are the same those cited in the above section of “Substrate” under “A. optical functional film”, and thus not repeated here.

### (2) Optical Functional Layer

An optical functional layer used for the optical film will be explained. The optical functional layer used for the optical film is formed directly on the substrate and contains a rodlike compound forming random homogeneous alignment while also exhibits optical uniaxiality.

The random homogeneous alignment formed in the optical functional layer will be explained. Three features of the “anisotropy”, “dispersibility” and “in-plane alignment properties” are explained in the above section of “A. optical functional film” in terms of the irregular-random homogeneous alignment. The random homogeneous alignment formed in the optical functional layer of the optical film has “irregularity” instead of the “anisotropy”. Thus, the random homogeneous alignment formed in the optical functional layer of the optical film has three features of the “irregularity”, “dispersibility” and “in-plane alignment properties”.

Here, the “irregularity” means that when the optical functional film is viewed just from the perpendicular direction to the surface of the optical functional layer, the alignment directions of the rodlike compounds are random in the optical functional layer.

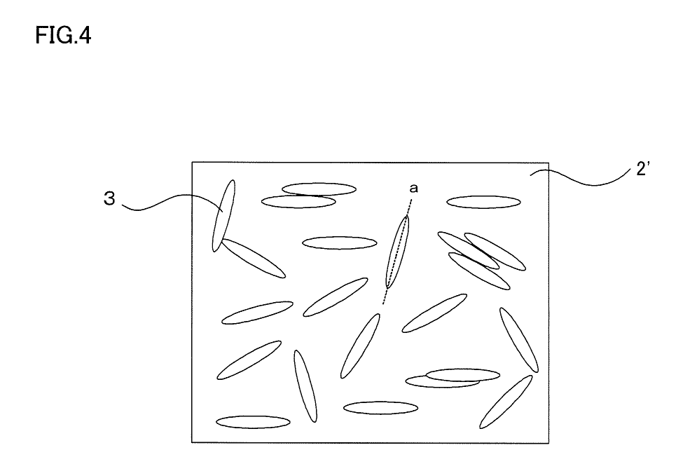

The “irregularity” will be explained with reference to the drawings. FIG. 4 is the schematic view when the optical film 20 is viewed just from the perpendicular A direction to the surface of the optical functional layer of the optical film 20 as shown in FIG. 3A. As shown in FIG. 4, the “irregularity” means that the rodlike compounds 3 are aligned randomly in the optical functional layer 2′ when the optical film 20 is viewed just from the perpendicular direction to the surface of the optical functional layer 2′.

Here, when the alignment directions of the rodlike compounds 3 are to be explained in the present invention, the long-axis direction of the molecule (hereinafter, referred to as “molecular axis”) shown by “a” in FIG. 4 is considered as a reference. Therefore, that the alignment directions of the rodlike compounds are random means that the molecular axes “a” of the rodlike compounds 3 contained in the optical functional layer are directed randomly.

When the rodlike compound has a cholesteric structure other than the sequence state illustrated in FIG. 4, this formally corresponds to the “irregularity”, because the directions of the molecular axes “a” are random as a whole. However, the state resulting from the cholesteric structure is not included in the “irregularity” in the present invention.

Next, a method for confirming the “irregularity” will be explained. The “irregularity” can be confirmed by evaluating the in-plane retardation (Re) of the optical functional layer constituting the optical film and by evaluating whether a selective reflection wavelength resulting from the cholesteric structure exists or not.

That is, that the rodlike compounds are aligned randomly can be confirmed by evaluating the Re of the optical functional layer constituting the optical functional film, and that the rodlike compounds do not form the cholesteric structure can be confirmed by based on whether the selective reflection wavelength exists or not.

That the above rodlike compounds are aligned randomly can be confirmed by ascertaining that the value of the in-plane retardation (Re) of the optical functional layer is in the range showing that the rodlike compound is in the random alignment. Particularly, in the present invention, the in-plane retardation (Re) of the optical functional layer is preferably in the range of 0 nm to 5 nm. Here, the definition and the measuring method of the Re are identical to those explained in the above section “A. Optical functional film”, and thus omitted here.

That the above rodlike compound has no cholesteric structure can be evaluated by confirming that the optical functional layer constituting the optical film has no selective reflection wavelength, with use of a UV-VIS-NIR spectrophotometer (UV-3100 or the like) manufactured by Shimadzu Corporation. This is because, when the rodlike compound takes the cholesteric structure, it is characterized in that it has the selective reflection wavelength depending upon the spiral pitch of the cholesteric structure.

The “dispersibility” and “in-plane alignment properties” possessed by the random homogeneous alignment are identical to those explained in the above section “A. Optical functional film”, and thus are omitted here.

Here, the word “optical uniaxiality” denotes that the optical functional layer of the optical film has one optical axis which is optically isotropic. Thus, the optical uniaxiality described in the present invention means that the subject has one optically isotropic optical axis. Exhibition of the optical uniaxiality of the optical functional layer can be evaluated by confirming the realization of the relation: nx=ny≠nz among a refractive index “nx” in a slow axis direction of the optical functional film, an refractive index “ny” in a fast axis direction of the optical functional film, and the refractive index “nz” in a thickness direction.

The realization of the above-mentioned relation among the “nx”, “ny” and “nz” can be measured by a parallel Nicol rotation method with use of KOBRA-WR manufactured by Oji Scientific Instruments.

Further, the rodlike compound contained in the optical functional layer of the optical film, and other factors regarding the optical functional layer are identical to those explained in the above section “A. optical functional film”, and thus are omitted here.

### (3) Producing Method of an Optical Film

Next, a producing method of an optical film used in the present invention will be explained. The producing method of an optical functional film used in the present invention is not particularly limited, so long as it can form the optical functional layer having the random homogeneous alignment on the above substrate. A method for coating on the substrate a composition for forming an optical functional layer prepared by dissolving the above rod-like composition is ordinarily used. Since the rodlike compound can be penetrated into the substrate together with the solvent in such a method, the interaction between the rodlike compound and the material constituting the substrate can be strengthen, so that the rodlike compound is likely to form the random homogeneous alignment. In the following, the producing method of an optical film will be explained.

The above composition for forming an optical functional layer ordinarily comprises the rodlike compound and the solvent, and may contain other compound, if necessary. Note that the rodlike compound used in the composition for forming an optical functional layer and the substrate are identical with those explained in the above “1. Substrate” and “2. Optical functional layer”, and thus explanation is omitted here.

The solvent used in the composition for forming an optical functional layer is not particularly limited, so long as it can solve the rodlike compound at a given concentration. As the solvent used in the present invention, for example, hydrocarbon based solvents such as benzene and hexane: ketone based solvents such as methyl ethyl ketone, methyl isobutyl ketone and cyclohexanone; ether based solvents such as tetrahydrofuran and 1,2-dimethoxy ethane; halogenated alkyl based solvents such as chloroform and dichloromethane; ester based solvents such as methyl acetate, butyl acetate and propylene glycol monomethyl ether acetate; amide based solvents such as N,N-dimethyl formamide; or sulfoxide based solvents such as dimethyl sulfoxide can be presented, however, it is not limited thereto. The solvent may be a single kind or a mixture of at least two kinds.

Among the above solvents, in the present invention, a ketone based solvent is preferably used, and cyclohexane is particularly favorably used.

The content of the rodlike compound in the composition for forming an optical functional layer is not particularly limited, so long as it is in such a range as to set the viscosity of the composition for forming an optical functional layer at a desired value depending upon factors such as a coating system for coating the composition for forming optical functional layer on the substrate. Most of all, in the present invention, the content of the rodlike compound in the composition for forming an optical functional layer is preferably in the range of 20 mass % to 90 mass %, more preferably in the range of 30 mass % to 80 mass %, most preferably in the range of 40 mass % to 70 mass %.

A photopolymerization initiator may be included in the composition for forming an optical functional layer, if needed. Particularly when the optical functional layer is cured by irradiation with ultraviolet rays, the photopolymerization initiator is preferably included. As the photopolymerization initiating agent, for example, benzophenone, o-benzoyl methyl benzoate, 4,4-bis(dimethyl amine) benzophenone, 4,4-bis(diethyl amine) benzophenone, α-amino-acetophenone, 4,4-dichlorobenzophenone, 4-benzoyl-4-methyl diphenyl ketone, dibenzyl ketone, fluolenone, 2,2-diethoxy acetophenone, 2,2-dimethoxy-2-phenyl acetophenone, 2-hydroxy-2-methyl propiophenone, p-tert-butyl dichloroacetophenone, thioxantone, 2-methyl thioxantone, 2-chlorothioxantone, 2-isopropyl thioxantone, diethyl thioxantone, benzyl dimethyl ketal, benzyl methoxy ethyl acetal, benzoin methyl ether, benzoin butyl ether, anthraquinone, 2-tert-butyl anthraquinone, 2-amyl anthraquinone, β-chloranthraquinone, anthrone, benzanthrone, dibenzsuberone, methylene anthrone, 4-adidobenzyl acetophenone, 2,6-bis (p-adidobendilidene) cyclohexane, 2,6-bis (p-adidobendilidene)-4-methyl cyclohexanone, 2-phenyl-1,2-butadion-2-(o-methoxy carbonyl) oxime, 1-phenyl-propane dion-2-(o-ethoxy carbonyl) oxime, 1,3-diphenyl-propane trion-2-(o-ethoxy carbonyl) oxime, 1-phenyl 3-ethoxy-propane trion-2-(o-benzoyl) oxime, Michler's ketone, 2-methyl-1[4-(methyl thio) phenyl]-2-morpholino propane-1-on, 2-benzyl-2-dimethyl amino-1-(4-morpholino phenyl)-butanone, naphthalene sulfonyl chloride, quinoline sulfonyl chloride, n-phenyl thioacrydone, 4,4-azo bis isobuthylonitrile, diphenyl disulfide, benzthiazol disulfide, triphenyl phosphine, camphor quinine, N1717 produced by Asahi Denka Co., Ltd., carbon tetrabromate, tribromo phenyl sulfone, benzoin peroxide, eosin, or a combination of a photo reducing pigment such as a methylene blue and a reducing agent such as ascorbic acid and triethanol amine can be presented as an example. In the present invention, these photo polymerization initiating agents can be used only by one kind or as a combination of two or more kinds.

Furthermore, in the case of using the photo polymerization initiating agent, a photo polymerization initiating auxiliary agent can be used in combination. As such a photo polymerization initiating auxiliary agent, tertiary amines such as triethanol amine, and methyl diethanol amine; benzoic acid derivatives such as 2-dimethyl aminoethyl benzoic acid and 4-dimethyl amide ethyl benzoate, or the like can be presented, however, it is not limited thereto.

In the composition for forming an optical functional layer of the present invention, the following compounds may be added in the range not to deteriorate the purpose of the present invention. As the compound to be added, for example, polyester (meth)acrylate obtained by reacting (meth)acrylic acid with a polyester prepolymer obtained by condensation of a polyhydric alcohol and a monobasic acid or a polybasic acid; polyurethane (meth)acrylate obtained by reacting a polyol group and a compound having two isocyanate groups, and reacting the reaction product with (meth)acrylic acid; a photo polymerizable compound such as epoxy (meth)acrylate obtained by reacting (meth) acrylic acid with epoxy resins such as a bisphenol A type epoxy resin, a bisphenol F type epoxy resin, a novolak type epoxy resin, polycarboxylic acid glycidyl ester, polyol polyglycidyl ether, an aliphatic or alicyclic epoxy resin, an amino group epoxy resin, a triphenol methane type epoxy resin, and a dihydroxy benzene type epoxy resin; or a photo polymerizable liquid crystalline compound having an acrylic group or a methacrylic group can be presented. The addition amount of these compounds with respect to the composition for forming an optical functional layer can be determined in the range not to deteriorate the purpose of the present invention. Since the compounds mentioned above are added, the mechanical strength of the optical functional layer can be improved so that the stability may be improved.

Other compound than the above may be included in the composition for forming an optical functional layer, if needed. Other compound, which depends upon factors such as the application of the optical functional film of the present invention, is not particularly limited, so long as it does not damage the optical characteristics of the optical functional layer of the present invention.

As the coating method for coating the composition for forming an optical functional layer onto the alignment layer is not particularly limited as long as it is a method capable of achieving a desired flatness. As the method, for example, the gravure coating method, the reverse coating method, the knife coating method, the dip coating method, the spray coating method, the air knife coating method, the spin coating method, the roll coating method, the printing method, the dipping and pulling up method, the curtain coating method, the die coating method, the casting method, the bar coating method, the extrusion coating method, or the E type applying method can be presented, but they are not limited thereto.

The thickness of the coated film of the composition for forming an optical functional layer is not particularly limited as long as it is in the range capable of achieving a desired flatness. In general, it is in the range of 0.1 μm to 50 μm; it is more preferably in the range of 0.5 μm to 30 μm; and it is particularly preferably in the range of 0.5 μm to 10 μm. In the case the thickness of the coated film of the composition for forming an optical functional layer is thinner than the above-mentioned range, the flatness of the optical functional layer to be formed may be deteriorated. Moreover, in the case the thickness is thicker than the above-mentioned range, due to the increase of the dry load of the solvent, the productivity may be lowered.

As the method for drying the coated film of the composition for forming an optical functional layer, a commonly used drying method such as the heat drying method, the pressure reducing drying method, and the gap drying method can be used. Moreover, the drying method in the present invention is not limited to a single method. For example, a plurality of drying methods may be adopted by an embodiment such as where the drying methods are changed successively according to the residual solvent amount.

In the case of using a polymerizable material as the rodlike compound, the method for polymerizing the polymerizable material can be determined optionally according to the kind of the polymerizable functional group of the polymerizable material. In particular, in the present invention, a method of curing the material by the active radiation is preferable. The active radiation is not particularly limited as long as it is a radiation capable of polymerizing the polymerizable material. In general, it is preferable to use an ultraviolet ray or a visible light beam in terms of factors such as the device convenience. In particular, it is preferable to use an irradiation beam having a 150 nm to 500 nm wavelength, more preferably 250 nm to 450 nm, and most preferably 300 nm to 400 nm.

As the light source for the irradiation beam, for example a low pressure mercury lamp (a sterilizing lamp, a fluorescent chemical lamp, a black light), a high pressure discharge lamp (a high pressure mercury lamp, a metal halide lamp), or a short arc discharge lamp (a ultra high pressure mercury lamp, a xenon lamp, a mercury xenon lamp) can be presented. In particular, use of such as the metal halide lamp, the xenon lamp, or the high pressure mercury lamp can be recommended. Moreover, the irradiation can be carried out while optionally adjusting the irradiation intensity according to such as the content of the photo polymerization initiating agent.

### 2. Stretching Method of an Optical Film

Next, a stretching method of the optical film used in the producing method of the optical functional film of the present invention will be explained.

The stretching method is not particularly limited so long as the method can: make the substrate constituting the optical film realize the relation: nx≠ny or nx≠ny≠nz among a refractive index “nx” in a slow axis direction of an in-plane direction, a refractive index “ny” in a fast axis direction of an in-plane direction, and a refractive index “nz” in a thickness direction; and provide optical biaxiality to the optical functional layer by changing the random homogeneous alignment into the irregular-random homogeneous alignment. The stretching method may be a biaxial stretching or a uniaxial stretching. In the present invention, a uniaxial stretching is preferable.

The uniaxial stretching may be a method to stretch to a flow direction of the film, or may be a method wherein an interval in a flow direction of the film is fixed and the film is stretched to the width direction.

A stretch ratio of stretching the optical film may be adjusted in accordance to the optical characteristics required for the optical functional film produced by the present invention.

### 3. Optical Functional Film

Next, an optical functional film produced by the producing method of the present invention will be explained. The optical functional film produced by the present invention comprises: a substrate having at least a property as an optically A-plate or B-plate; and an optical functional layer, formed directly on the substrate, which exhibits optical biaxiality and contains a rodlike compound forming irregular-random homogeneous alignment.

The optical functional film produced by the present invention is identical to that explained in the above section “A. optical functional film”, and thus omitted here.

The present invention is not limited to the above-mentioned embodiments. The embodiments are examples and any one having the substantially same configuration as the technological idea disclosed in the claims of the present invention so as to achieve the same effects is incorporated in the technological scope of the present invention.

### EXAMPLES

Hereinafter, the present invention will be explained specifically with reference to the example.

### (1) Example 1

### Production of an Optical Film

Into cyclohexane was dissolved a compound (I) expressed by the following formula as a rodlike compound in an amount of 20 mass %, and the resultant was coated onto a substrate made of a TAC film (manufactured by FUJIFILM Corporation, Trade name: TF80UL, thickness of 80 μm) by bar coating in a coated amount of 2.5 g/m² after drying. Subsequently, the solvent was dried off by heating at 90° C., for 4 minutes, the rodlike compound was penetrated into the TAC film, and the rodlike compound was fixed by irradiating the coated face with ultraviolet rays, thereby producing an optical film.

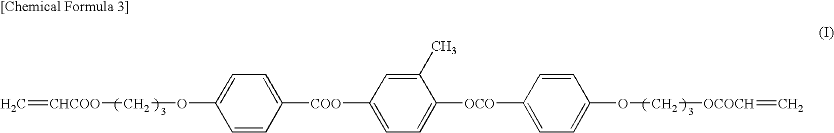

With respect to the produced optical film and the TAC film, the Rth and the Re were measured according to the parallel Nicol rotation method by using the KOBRA-WR manufactured by Oji Scientific Instruments. Here, Trade name: KOBRA-21ADH manufactured by Oji Scientific Instruments was used for the measurements of the Re and Rth. Meanwhile, Trade name: NDH2000 manufactured by Nippon Denshoku Industries Co., Ltd. was used for the measurement of the haze. Further, Trade name: UV-3100PC manufactured by Shimazdu Corporation was used for confirming the presence or absence of the selective reflection wavelength. As a result, Rth=118 nm, and Re=0 nm. Meanwhile, the haze was 0.2%. In addition, it was confirmed by a UV-VIS-NIR spectrophotometer (UV-3100) manufactured by Shimazdu Corporation that the optical film has no selective reflection wavelength. Thereby, in the retardation layer of the produced optical film, it was confirmed that the compound (I) was aligned randomly and homogeneously.

### (Stretching of the Optical Film)

Next, the optical film was heated on a hot plate at 120° C. for 5 minutes and stretched by stretch ratio of 1.20 to produce an optical functional film. The produced optical functional film was taken as a sample to conduct the following evaluation.

### 1. Optical Biaxiality

The retardation of the stretched sample was measured by the automatic birefringence measuring instrument (manufactured by Oji Scientific Instruments, Trade name: KOBRA-21ADH). Moreover, the three-dimensional refractive index was measured by the same measurement device. The following results were found: nx=1.60, ny=1.58 and nz=1.52.

### 2. Irregular-Random Homogeneous Alignment

With respect to the produced optical functional film and the TD80UL, the Rth and the Re were measured according to the parallel Nicol rotation method by using the KOBRA-WR manufactured by Oji Scientific Instruments. Here, Trade name: KOBRA-21ADH manufactured by Oji Scientific Instruments was used for the measurements of the Re and Rth. Meanwhile, Trade name: NDH2000 manufactured by Nippon Denshoku Industries Co., Ltd. was used for the measurement of the haze. Further, Trade name: UV-3100PC manufactured by Shimazdu Corporation was used for confirming the presence or absence of the selective reflection wavelength. Rth and Re of the optical functional layer were calculated from the measuring results. The following results were found: Rth=145 nm, and Re=43 nm. Meanwhile, the haze was 0.4%.

In addition, it was confirmed by a UV-VIS-NIR spectrophotometer (UV-3100) manufactured by Shimazdu Corporation that the optical functional film has no selective reflection wavelength.

### 3. Adhesion Property Test

In order to examine the adhesion property, a peeling test was carried out. In the peeling test, 1 mm-square cut lines were formed on the obtained sample in a grid fashion. An adhesive tape (manufactured by NICHIBAN CO., LTD., Cellotape®) was bonded to a liquid crystal face, then the tape was peeled off, and observation was made by eyes. As a result, the adhesion degree was 100%.

Adhesion degree (%)=(non-peeled portion/tape-bonded area)×100.

### 4. Wet Heat Resistance Test-1

A sample was immersed in hot water at 90° C., for 60 minutes, and the optical characteristics and the adhesion property were measured by the above-mentioned methods. As a result, no change was seen in the optical characteristics and the adhesion property before and after the testing.

### 5. Wet Heat Resistance Test-2

A sample was left at rest in an environment of a humidity 95% at 80° C., for 24 hours, and the optical characteristics and the adhesion property were measured by the above-mentioned methods. As a result, no change was seen in the optical characteristics and the adhesion property before and after the testing. Meanwhile, neither oozing nor clouding of the refractive index anisotropic material was seen after the testing.

### 6. Water Proof Test

A sample was immersed into pure water at room temperature (23.5° C.), for one day, and the optical characteristics and the adhesion property were measured by the above-mentioned methods. As a result, no change was seen in the optical characteristics and the adhesion property before and after the testing.

### 7. Alkaline Resistance Test

A sample was immersed into an alkaline aqueous solution (1.5N aqueous solution of sodium hydroxide) at 55° C., for 3 minutes, washed and dried, and the optical characteristics and the adhesion property were measured by the above-mentioned methods. As a result, no change was seen in the optical characteristics and the adhesion property before and after the testing. Furthermore, no coloring was seen.

### (2) Comparative Example 1

Mixed were 75 parts by weight of a liquid crystal material (below formula II) having polymerizable acrylate groups at both ends and a spacer between the central mesogen and the acrylate; 1 part by weight of IRGACURE Irg 184 (manufactured by Ciba Specialty Chemicals) as a photopolymerization initiator; and 25 parts by weight of toluene as a solvent. Further, 10 pats by weight of a chiral agent (below formula III) having polymerizable acrylate groups at both ends was mixed to the resultant as a chiral agent to prepare a coating solution for forming an optical functional layer.

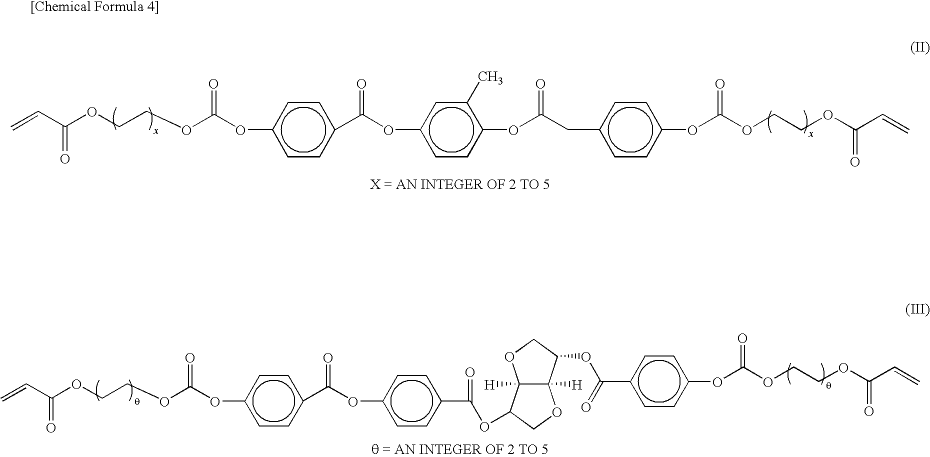

Using a substrate made of cycloolefin-based polymer having a thickness of 80 μm and no in-plane retardation (Re) (Trade name: ARTON, manufactured by JSR Corporation), the coating solution for forming an optical functional layer was coated on the substrate by a spin-coating method. Next, the film coated with the coating solution for forming an optical functional layer was heated on a hot plate at 100° C. for 5 minutes, and the residual solvent was removed to realize a twist-aligned liquid crystal structure. Subsequently, the coated film was irradiated with ultraviolet rays (20 mJ/cm², wavelength of 365 nm) and an optical functional layer having a thickness of 4.0 μm where the liquid crystal material formed Chiral Nematic (cholesteric) alignment was obtained. At this time, the spiral pitch of the liquid crystal material was 180 nm and the reflected wavelength of the optical functional layer was 280 nm.

The substrate where the optical functional layer was formed was heated at 145° C. for 1 minute and then stretched by a stretch ratio of 1.5. As a result, peeling was found between the substrate and the optical functional layer and no optical functional film was produced.

### (3) Example 2

### Production of an Optical Functional Film

Dissolved into cyclohexane was a photopolymerizable liquid crystal compound expressed by the following formula as a refractive index anisotropy-material in an amount of 15 mass %, and the resultant was coated onto a TAC film (manufactured by Konica Minolta Holdings, Inc., Trade name: KC8UX2MW, thickness of 80 μm) by bar coating in a coated amount of 4.11 g/m² after drying.

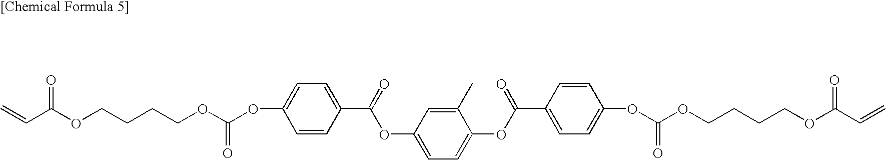

Next, the coated film was heated at 40° C. for 1 minute and at 80° C. for 1 minute, and the solvent was dried and removed. The photopolymerizable liquid crystal compound was mixed with the polymer provided at the surface of the substrate and aligned. Further, the coated surface was irradiated with ultraviolet rays to fix the photopolymerizable liquid crystal compound and thereby an optical film was produced.

### (Stretching of the Optical Film)

Next, the optical film was heated at 145° C. for 1 minute and stretched by an optional stretch ratio to form an optical functional film. The obtained optical functional film was taken as a sample and evaluated regarding the following items.

### 1. Optical Biaxiality

The retardation of a sample was measured by the automatic birefringence measuring instrument (manufactured by Oji Scientific Instruments). Measuring light was introduced perpendicularly or obliquely to a surface of the sample, and the anisotropic property to increase the retardation of the substrate film was confirmed based on a chart of the optical retardation and the incident angle of the measuring light. Further, refractive indexes of the optical functional layer were measured with the above measuring instrument and the following results were confirmed: nx=1.60, ny=1.58 and nz=1.52. Since the relation: nx>ny>nz was realized, it was confirmed that the optical functional layer has a property as an optically negative B-plate.

In addition, it was confirmed by a UV-VIS-NIR spectrophotometer (manufactured by Shimazdu Corporation, Trade name: UV-3100) that all of the optical functional films shown in Table 1 have no selective reflection wavelength.

### 2. Haze

In order to examine the transparency of a sample, the haze value was measured by a turbidimeter (manufactured by Nippon Denshoku Industries Co., Ltd., trade name: NDH2000). The result was good with not more than 0.3% at a coated amount of 3.76 g/m² and 4.11 g/m².

### 3. Adhesion Property Test

In order to examine the adhesion property, a peeling test was carried out. In the peeling test, 1 mm-square cut lines were formed on the obtained sample in a grid fashion. An adhesive tape (manufactured by NICHIBAN CO., LTD., Cellotape®) was bonded to a liquid crystal face, then the tape was peeled off, and observation was made by eyes. As a result, the adhesion degree was 100%.

Adhesion degree (%)=(non-peeled portion/tape-bonded area)×100.

### 4. Wet Heat Resistance Test

A sample was placed under an environment of 90% RH at 60° C., for 1000 hours, and the adhesion property was measured by the above-mentioned methods. As a result, no change was seen in the adhesion property before and after the testing.

### 5. Water Proof Test

A sample was immersed into pure water at room temperature (23.5° C.), for one day, and the adhesion property was measured by the above-mentioned methods. As a result, no change was seen in the adhesion property before and after the testing.

### 6. Alkaline Resistance Test

A sample was immersed into an alkaline aqueous solution (1.5N aqueous solution of sodium hydroxide) at 55° C., for 3 minutes, and washed and dried, and the optical characteristics and the adhesion property were measured by the above-mentioned methods. As a result, no change was seen in the optical characteristics and the adhesion property before and after the testing. Furthermore, no coloring was seen.

### 7. Raman Peak Intensity Ratio

Using a laser Raman spectrophotometer (manufactured by JASCO Corporation, Trade name: NRS-300), Raman scattering spectra in an in-plane direction and a thickness direction of the optical functional layer of the sample were measured. The measuring conditions were: 15 seconds of exposing time, 8 times of integrating time and 532.11 nm in excitation wavelength.

Here, the Raman scattering spectrum in the in-plane direction was measured by entering a measuring light into the optical functional layer in a manner that the electric field oscillating surface of the liner-polarized light coincides with the slow axis direction and the fast axis direction of in-plane of the optical functional layer. Each Raman scattering spectrum is measured regarding the slow axis direction and the fast axis direction in the plane. Subsequently, a peak intensity at 1605 cm⁻¹ and a peak intensity at 2942 cm⁻¹ are evaluated for the obtained spectra and the Raman peak intensity ratio (1605 cm⁻¹/2942 cm⁻¹) was obtained.

Further, the Raman scattering spectrum in the thickness direction was measured by entering a measuring light into the cross-section in a thickness direction of the optical functional layer in a manner that the electric field oscillating surface of the liner-polarized light coincides with the parallel direction to and the perpendicular direction to the thickness direction. Each Raman scattering spectrum is measured regarding the parallel direction to and the perpendicular direction to the thickness direction of the cross-section in the thickness direction. Subsequently, a peak intensity at 1605 cm⁻¹ and a peak intensity at 2942 cm⁻¹ are calculated. The results are shown in Table 1.

Table 1 also shows the Raman peak intensity ratio of the substrates and the optical films before stretching.

TABLE 1

| | | | ELECTRIC FIELD | |
|---|---|---|---|---|
| | ENTERING DIRECTION OF | | OSCILLATING SURFACE OF | RAMAN PEAK |
| SAMPLE | MEASURING LIGHT | MEASURING OBJECT | LINER-POLALIZED LIGHT | INTENSITY RATIO |
| OPTICAL FUNCTIONAL | IN-PLANE DIRECTION | ENTIRE OPTICAL | SLOW AXIS DIRECTION | 1.534 |
| FILM | | FUNCTIONAL FILM | | |
| OPTICAL FUNCTIONAL | IN-PLANE DIRECTION | ENTIRE OPTICAL | FAST AXIS DIRECTION | 1.117 |
| FILM | | FUNCTIONAL FILM | | |
| OPTICAL FUNCTIONAL | THICKNESS DIRECTION | OPTICAL | PERPENDICULAR TO | 0.901 |
| FILM | (CROSS-SECTION IN SLOW | FUNCTIONAL LAYER | THICKNESS DIRECTION | |
| | AXIS DIRECTION) | | | |
| OPTICAL FUNCTIONAL | THICKNESS DIRECTION | OPTICAL | PARALLEL TO THICKENSS | 0.325 |
| FILM | (CROSS-SECTION IN SLOW | FUNCTIONAL LAYER | DIRECTION | |
| | AXIS DIRECTION) | | | |
| OPTICAL FUNCTIONAL | THICKNESS DIRECTION | OPTICAL | PERPENDICULAR TO | 0.641 |
| FILM | (CROSS-SECTION IN FAST | FUNCTIONAL LAYER | THICKNESS DIRECTION | |
| | AXIS DIRECTION) | | | |
| OPTICAL FUNCTIONAL | THICKNESS DIRECTION | OPTICAL | PARALLEL TO THICKENSS | 0.318 |
| FILM | (CROSS-SECTION IN FAST | FUNCTIONAL LAYER | DIRECTION | |
| | AXIS DIRECTION) | | | |
| OPTICAL FILM | IN-PLANE DIRECTION | ENTIRE OPTICAL | DIRECTION OF | 0.775 |
| (BEFORE STRETCHING) | | FUNCTIONAL FILM | FILM-WIDTH | |
| OPTICAL FILM | IN-PLANE DIRECTION | ENTIRE OPTICAL | LONGITUDINAL | 0.756 |
| (BEFORE STRETCHING) | | FUNCTIONAL FILM | DIRECTION OF FILM | |
| OPTICAL FILM | THICKNESS DIRECTION | OPTICAL | PERPENDICULAR TO | 1.033 |
| (BEFORE STRETCHING) | | FUNCTIONAL LAYER | THICKNESS DIRECTION | |
| OPTICAL FILM | THICKNESS DIRECTION | OPTICAL | PARALLEL TO THICKENSS | 0.467 |
| (BEFORE STRETCHING) | | FUNCTIONAL LAYER | DIRECTION | |
| SUBSTRATE | THICKNESS DIRECTION | SUBSTRATE | PERPENDICULAR TO | 0.225 |
| | | | THICKNESS DIRECTION | |
| SUBSTRATE | THICKNESS DIRECTION | SUBSTRATE | PARALLEL TO THICKENSS | 0.191 |
| | | | DIRECTION | |

Here, the “cross-section in slow axis direction” shown in Table 1 means a cross-section obtained when the optical functional film is cut in a direction parallel to the slow axis direction of the in-plane of the optical functional film. On the other hand, the “cross-section in fast axis direction” means a cross-section obtained when the optical functional film is cut in a direction perpendicular to the slow axis direction of the in-plane of the optical functional film.

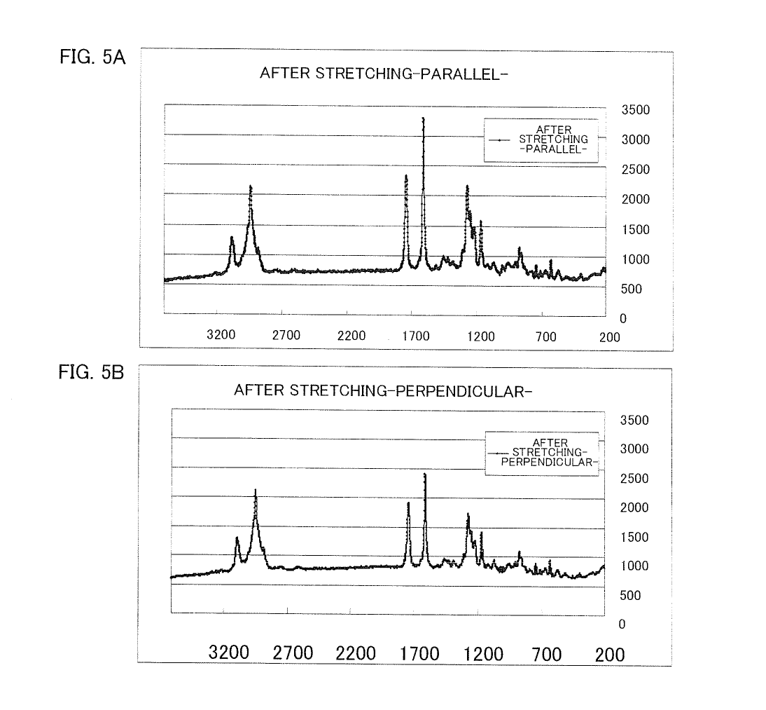

Further, an example of the Raman scattering spectrum is shown in each of FIGS. 5A and 5B. FIGS. 5A and 5B are Raman scattering spectra in an in-plane direction of the optical functional film in its entirety. FIG. 5A is a spectrum measured by entering a measuring light into the optical functional layer in a manner that the electric field oscillating surface of the liner-polarized light coincides with the slow axis direction; and FIG. 5B is a spectrum measured by entering a measuring light into the optical functional layer in a manner that the electric field oscillating surface of the liner-polarized light coincides with the fast axis direction. The Raman peak intensity ratio was calculated by reading a peak intensity at 1605 cm⁻¹ and a peak intensity at 2942 cm⁻¹.

1. An optical functional film which exhibits optical biaxiality and comprises:
a substrate; and
an optical functional layer formed on the substrate and having a rodlike compound,
wherein the rodlike compound forms irregular-random homogeneous alignment in the optical functional layer.

2. The optical functional film according to claim 1, wherein the relation: nx>ny>nz is realized among a refractive index “nx” in a slow axis direction of an in-plane direction,
a reflactive index “ny” in a fast axis direction of an in-plane direction, and a reflactive index “nz” in a thickness direction.

3. The optical functional film according to claim 1, wherein an in-plane retardation (Re) is in the range of 10 nm to 200 nm.

4. The optical functional film according to claim 1, wherein a retardation in a thickness direction (Rth) is in the range of 75 nm to 300 nm.

5. The optical functional film according to claim 1, wherein the rodlike compound has a polymerizable functional group.

6. The optical functional film according to claim 1, wherein the rodlike compound is a liquid crystalline material.

7. The optical functional film according to claim 6, wherein the liquid crystalline material is a material exhibiting a nematic phase.

8. The optical functional film according to claim 1, wherein the substrate realizes the relation: nx≠ny among a reflactive index “nx” in a slow axis direction of an in-plane direction, and a reflactive index “ny” in a fast axis direction of an in-plane direction.

9. The optical functional film according to claims 1, wherein the substrate realizes the relation: nx≠ny≠nz among a reflactive index “nx” in a slow axis direction of an in-plane direction, a reflactive index “ny” in a fast axis direction of an in-plane direction, and a reflactive index “nz” in a thickness direction.

10. The optical functional film according to claim 1, wherein the rodlike compound has a rodlike-main skeleton having plural benzene rings; and
wherein a Raman peak intensity ratio (1605 cm⁻¹/2942 cm⁻¹) in a slow axis direction of in-plane of the optical functional layer is 1.1 times or more of a Raman peak intensity ratio (1605 cm⁻¹/2942 cm⁻¹) in a fast axis direction of the in-plane.

11. The optical functional film according to claim 1, wherein the rodlike compound has a rodlike-main skeleton having plural benzene rings; and
wherein a cross-section in a thickness direction of the optical functional layer has a Raman peak intensity ratio (1605 cm⁻¹/2942 cm⁻¹) in a direction perpendicular to the thickness direction which is 1.1 times or more of a Raman peak intensity ratio (1605 cm⁻¹/2942 cm⁻¹) in a direction parallel to the thickness direction.

12. The optical functional film according to claim 1, wherein the substrate is made of a cellulose derivative.

13. A production method of an optical functional film to produce an optical functional film comprising:
a substrate which realizes the relation: nx≠ny or nx≠ny≠nz among a reflactive index “nx” in a slow axis direction of an in-plane direction, a reflactive index “ny” in a fast axis direction of an in-plane direction, and a reflactive index “nz” in a thickness direction; and
an optical functional layer formed on the substrate, in which the optical functional layer exhibits optical biaxiality and contains a rodlike compound forming irregular-random homogeneous alignment,
wherein the production method comprises a step of stretching an optical film which comprises:
a substrate having at least a property as an optically negative C-plate; and
an optical functional layer formed directly on the substrate, in which the optical functional layer exhibits optical uniaxiality and contains a rodlike compound forming random homogeneous alignment.
